(19) United States
(12) Patent Application Publication
(10) Pub. No.: US 2026/0188216 A1
(43) Pub. Date: Jul. 2, 2026

(54) DISPLAY DEVICE

(71) Applicant: LG Display Co., Ltd., Seoul (KR)

(72) Inventor: YoungJoon Lee, Paju-si (KR)

(73) Assignee: LG Display Co., Ltd., Seoul (KR)

(21) Appl. No.: 19/222,292

(22) Filed: May 29, 2025

(30) Foreign Application Priority Data
Dec. 30, 2024 (KR) 10-2024-0199863

(51) Int. Cl. G09G 3/3233

(52) U.S. Cl. CPC G09G 3/3233; G09G 2300/0819; G09G 2300/0842; G09G 2310/08

(57) ABSTRACT

A display device including a display area and an optical area overlapping an electronic optical device disposed below optical area; a plurality of light emitting devices disposed in the display area and the optical area; a first pixel circuit disposed in the display area and outside of the optical area and electrically connected to first light emitting devices disposed in the optical area and configured to provide a driving current to the first light emitting devices disposed in the optical area; and a second pixel circuit disposed in the display area and outside of the optical area and electrically connected to second light emitting devices disposed in the display area and configured to provide a driving current to the second light emitting devices disposed in the display area.

### CROSS REFERENCE TO RELATED APPLICATION

This application claims priority to Korean Patent Application No. 10-2024-0199863, filed in the Republic of Korea on Dec. 30, 2024, the entire contents of which is hereby incorporated by reference into the present application.

### BACKGROUND

### Technical Field

Embodiments of the present disclosure relate to a display device.

### Discussion of the Related Art

As the information society develops, the demand for display devices for displaying images is increasing in various forms, and recently, various display devices such as liquid crystal displays and organic light-emitting display devices are being utilized. In addition, the display device can provide a detection function to perform a function according to the light in the surrounding environment. For this purpose, the display device can be equipped with various electronic devices (e.g., optical electronic devices) such as a detection sensor and an image sensor (e.g., a camera).

Because an electronic device is required to receive light from the front of the display device, a transmission area including a cathode hole can be formed in an area of a cathode electrode where the electronic device is placed. However, the transmission area replaces an emission area of a light emitting device, and thus there can occur the problem of reduced readability when displaying a text image in the transmission area.

### SUMMARY

Accordingly, embodiments of the present disclosure can provide a display device having a transmission and display structure in which an optical electronic device requiring light reception is placed under a display panel, and a display area of the display panel overlapping with the optical electronic device (hereinafter referred to as an optical area) has a light transmission path as well as a display function.

Embodiments of the present disclosure can also provide a display device capable of securing an area through which light can pass by electrically connecting light emitting devices disposed in an optical area in an arbitrary number of units and disposing a pixel circuit for driving the electrically connected light emitting devices outside the optical area.

In addition, embodiments of the present disclosure can provide a display device capable of controlling the number of light emitting devices through which a driving current can flow, among light emitting devices arranged in an optical area and electrically connected in an arbitrary number. Embodiments can also provide a display device capable of displaying text without loss of a stroke by controlling driving current to flow to light emitting devices adjacent to a light emitting device on which text should be displayed when displaying a text image in the optical area.

Further, embodiments of the present disclosure can provide a display device capable of controlling the driving current to flow only to some of the light emitting devices among the light emitting devices electrically connected to each other when displaying text images in the optical area, thereby enabling text images displayed in the optical area to be distinguished without being adjacent to each other. Embodiments of the present disclosure can also provide a display device capable of improving readability by allowing text images to be separated without being adjacent to each other without loss of strokes when displaying text images in the optical area.

Embodiments of the present disclosure can provide a display device capable of displaying text images in an optical area at low power by controlling the number of light emitting devices emitting light in the optical area.

The tasks of the embodiments of the present disclosure are not limited to the tasks mentioned in this disclosure, and other tasks not mentioned will be clearly understood by those skilled in the art from the description below.

Embodiments of the present disclosure can provide a display device including a normal area and an optical area capable of transmitting light, a plurality of light emitting devices disposed in each of the normal area and the optical area, a first pixel circuit configured to provide a driving current to at least one of the plurality of light emitting devices disposed in the optical area, and at least one switch transistors connected between the plurality of light emitting devices.

Embodiments of the present disclosure can provide a display device including a normal area and an optical area surrounded by the normal area, M light emitting devices (M is a natural number greater than 3) arranged in the optical area, a first pixel circuit providing a driving current to N light emitting devices (N is a natural number greater than 1 and less than M) arranged in the optical area, and at least one switch transistor selectively blocking the driving current applied to a part of the N light emitting devices.

According to embodiments of the present disclosure, it is possible to provide a display device having a transmission and display structure in which an optical electronic device requiring light reception is placed under a display panel, and a display area of the display panel overlapping with the optical electronic device (hereinafter referred to as an optical area) has a light transmission path as well as a display function. It is also possible to provide a display device capable of securing an area through which light can pass by electrically connecting light emitting devices disposed in an optical area in an arbitrary number of units and disposing a pixel circuit for driving the electrically connected light emitting devices outside the optical area.

According to embodiments of the present disclosure, it is possible to provide a display device capable of controlling the number of light emitting devices through which a driving current can flow, among light emitting devices arranged in an optical area and electrically connected in an arbitrary number. It is also possible to provide a display device capable of displaying text without loss of a stroke by controlling driving current to flow to light emitting devices adjacent to a light emitting device on which text should be displayed when displaying a text image in the optical area.

Furrther, it is possible to provide a display device capable of controlling the driving current to flow only to some of the light emitting devices among the light emitting devices electrically connected to each other when displaying text images in the optical area, thereby enabling text images displayed in the optical area to be distinguished without being adjacent to each other. In addition, it is possible to provide a display device capable of improving readability by allowing text images to be separated without being adjacent to each other without loss of strokes when displaying text images in the optical area.

According to embodiments of the present disclosure, it is possible to provide a display device capable of displaying text images in an optical area at low power by controlling the number of light emitting devices emitting light in the optical area.

The effects of the embodiments of the present disclosure are not limited to the effects mentioned in this disclosure, and other effects not mentioned will be clearly understood by those skilled in the art from the description of the claims.

### BRIEF DESCRIPTION OF THE DRAWINGS

The present disclosure will be more fully understood from the detailed description and accompanying drawings provided below, which are provided for illustration only and are not intended to limit the present disclosure.

FIG. 1 is an overview illustrating a display device according to embodiments of the present disclosure.

FIG. 2 is a block diagram illustrating a display device according to embodiments of the present disclosure.

FIG. 3 is an overview illustrating a display panel according to embodiments of the present disclosure.

FIG. 4 is an overview illustrating a layout of sub-pixels in two areas included in the display area of the display panel according to embodiments of the present disclosure.

FIG. 5 is an overview illustrating light emitting devices arranged in a normal area, an optical bezel area, and an optical area, and pixel circuits for driving the light emitting devices in the display panel according to embodiments of the present disclosure.

FIG. 6 is an overview illustrating a matrix of light emitting devices matrix to which driving current is supplied in the case that “HH” text is displayed in the normal area according to embodiments of the present disclosure.

FIG. 7 is an overview illustrating a matrix of light emitting devices matrix to which driving current is supplied in the case that “HH” text is displayed in the optical area according to embodiments of the present disclosure.

FIG. 8 is an overview illustrating a matrix of light emitting devices to which driving current is supplied in the case that “HH” text is displayed in the optical area without loss of strokes according to embodiments of the present disclosure.

FIG. 9 is an overview illustrating light emitting devices arranged in a normal area, an optical bezel area, and an optical area, pixel circuits for driving the light emitting devices, and a switch transistor arranged in the optical bezel area in a display panel according to embodiments of the present disclosure.

FIG. 10 is an overview illustrating a matrix of light emitting devices to which a driving current is supplied in the case that the text “HH” is displayed in the optical area, when a switch transistor structure as in FIG. 9 is applied.

FIGS. 11-15 are circuit diagrams illustrating various embodiments of sub-pixels according to embodiments of the present disclosure.

FIG. 16 is a timing diagram for a signal supplied to a sub-pixel shown in FIG. 11.

### DETAILED DESCRIPTION

In the following description of examples or embodiments of the present invention, reference will be made to the accompanying drawings in which it is shown by way of illustration specific examples or embodiments that can be implemented, and in which the same reference numerals and signs can be used to designate the same or like components even when they are shown in different accompanying drawings from one another. The terms such as “including”, “having”, “containing”, “constituting” “make up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” can be used herein to describe elements of the present invention. Each of these terms is not used to define essence, order, sequence, or number of elements etc., but is used merely to distinguish the corresponding element from other elements.

When it is mentioned that a first element “is connected or coupled to”, “contacts or overlaps” etc. a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc. each other via a fourth element. Here, the second element can be included in at least one of two or more elements that “are connected or coupled to”, “contact or overlap”, etc. each other.

When time relative terms, such as “after,” “subsequent to,” “next,” “before,” and the like, are used to describe processes or operations of elements or configurations, or flows or steps in operating, processing, manufacturing methods, these terms can be used to describe non-consecutive or non-sequential processes or operations unless the term “directly” or “immediately” is used together.

In addition, when any dimensions, relative sizes etc. are mentioned, it should be considered that numerical values for an elements or features, or corresponding information (e.g., level, range, etc.) include a tolerance or error range that can be caused by various factors (e.g., process factors, internal or external impact, noise, etc.) even when a relevant description is not specified. Further, the term “can” fully encompasses all the meanings of the term “can”

Hereinafter, various embodiments of the disclosure are described in detail with reference to the accompanying drawings.

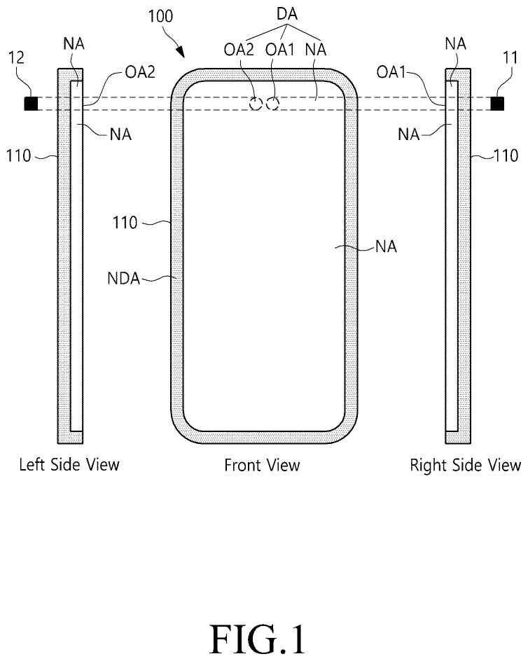

FIG. 1 illustrates a display device 100 according to embodiments of the present disclosure. As shown in FIG. 1, the display device 100 includes a display panel 110 for displaying an image and optical electronic devices 11 and 12. The display panel 110 includes a display area DA where an image is displayed and a non-display area NDA where an image is not displayed.

Also included is a plurality of sub-pixels and a plurality of signal lines for driving the plurality of sub-pixels in the display area DA. The non-display area NDA can be an area outside the display area DA, various signal lines can be disposed in the non-display area NDA, and various driving circuits can be connected thereto. The non-display area NDA can also be bent so that it is not visible from the front or can be obscured by a case. The non-display area NDA can also be also referred as a bezel or a bezel area.

Further, optical electronic devices 11 and 12 can be provided and installed separately from the display panel 110, and can be an electronic component located at the lower part of the display panel 110 (i.e., opposite the viewing surface). Light can thus enter the front (i.e., viewing side) of the display panel 110, pass through the display panel 110, and be delivered to the optical electronic devices 11 and 12 located below the display panel 110 (i.e., opposite the viewing surface). Light passing through the display panel 110 can include visible light, infrared light, or ultraviolet light.

Also, the electronic devices 11 and 12 can receive light passing through the display panel 110 and perform a predetermined function using the received light. For example, the optical electronic devices 11 and 12 can include a photographing device such as a camera (i.e., image sensor), a detection sensor such as a proximity sensor, and an illuminance sensor. Here, for example, the detection sensor can be an infrared sensor.

In addition, the display area DA can include a normal area NA and one or more optical areas OA1 and OA2 ovlerapping with optical electronic devices 11 and 12. According to the example of FIG. 1, the display area DA can include a normal area NA, a first optical area OA1, and a second optical area OA2. As shown, the normal area NA is between the first optical area OA1 and the second optical area OA2. Here, at least a portion of the first optical area OA1 can overlap with the first optical electronic device 11, and at least a portion of the second optical area OA2 can overlap with the second optical electronic device 12.

Also, the optical areas OA1 and OA2 include both an image display structure and a light transmission structure. That is, because the optical areas OA1 and OA2 are part of the display area DA, emission areas of sub-pixels for image display are disposed in the optical areas OA1 and OA2. Additionally, a light transmission structure is formed in optical areas OA1 and OA2 to transmit light to optical electronic devices 11 and 12.

As described above, the optical electronic devices 11 and 12 perform optical reception, and are located behind (i.e., below or opposite to the viewing surface) the display panel 110 and receive light passing through the display panel 110. The optical electronic devices 11 and 12 are also not exposed to the front (i.e., viewing side) of the display panel 110. Accordingly, when the user looks at the front of the display device 110, the optical electronic devices 11 and 12 are not completely visible to the user.

In addition, the first optical electronic device 11 can be a camera, and the second optical electronic device 12 can be a detection sensor such as a proximity sensor or illuminance sensor. For example, the detection sensor can be an infrared sensor for detecting infrared rays. Alternatively, the first optical electronic device 11 can be a detection sensor, and the second optical electronic device 12 can be a camera.

Hereinafter, for convenience of explanation, the first optical electronic device 11 is assumed to be a camera and the second optical electronic device 12 is assumed to be an infrared-based detection sensor. Here, the camera can be a camera lens or an image sensor.

When the first optical electronic device 11 is a camera, the camera can be located behind (i.e., below) the display panel 110, but still be used as a front camera for photographing the front direction of the display panel 110. Accordingly, the user can view a viewing surface of the display panel 110 and take pictures or self-photographs using the camera which is not completely visible to the viewing surface.

In addition, the normal area NA and optical areas OA1 and OA2 can be areas capable of dislaying an image. However, the normal area NA can be an area in which a light transmission structure is not formed, and the optical areas OA1 and OA2 can be areas in which a light transmission structure is formed. Therefore, the optical areas OA1 and OA2 preferably have transmittance above a specific level, and the normal area NA can have no light transmittance or have low transmittance below a specific level.

For example, the number of sub-pixels per unit area in the optical areas OA1 and OA2 can be smaller than the number of sub-pixels per unit area in the normal area NA. That is, the resolution of the optical areas OA1 and OA2 can be lower than the resolution of the normal area NA. Here, the number of sub-pixels per unit area can mean the same as resolution, pixel density, or pixel integration. For example, a unit of the number of sub-pixels per unit area can be PPI (Pixels Per Inch), which means the number of pixels in 1 inch.

In addition, the number of sub-pixels per unit area in the first optical area OA1 can be less than the number of sub-pixels per unit area in the normal area NA. The number of sub-pixels per unit area in the second optical area OA2 canalso be greater than or equal to the number of sub-pixels per unit area in the first optical area OA1, and can be less than the number of sub-pixels per unit area in the normal area NA.

As a method to increase the transmittance of at least one of the first optical area OA1 and the second optical area OA2, a differential pixel density design method can be applied, as described above. According to the differential pixel density design method, the display panel 110 can be designed with the number of sub-pixels per unit area of at least one of the first optical area OA1 and the second optical area OA2 to be less than the number of sub-pixels per unit area of the normal area NA.

Hereinafter, for convenience of explanation, it is assumed that the differential pixel density design method is applied as a method for increasing the transmittance of at least one of the first optical area OA1 and the second optical area OA2. Accordingly, in the following, a smaller number of sub-pixels per unit area can correspond to a smaller sub-pixel size, and a larger number of sub-pixels per unit area can correspond to a larger sub-pixel size.

In addition, the first optical area OA1 and the second optical area OA2 can have various shapes such as circular, oval, square, hexagon, or octagon. The first optical area OA1 and the second optical area OA2 can have the same shape or different shapes. The first and second optical areas OA1 and OA2 can also be located in different areas on the display such as in corner areas of the display, spaced apart from each other by a preset distance.

Hereinafter, for convenience of explanation, the first optical area OA1 and the second optical area OA2 are assumed to have a circular shape. Also, if the first optical electronic device 11, which is not exposed to the outside and is hidden at the bottom of the display panel 100, is a camera, the display device 100 can be referred as using an UDC (Under Display Camera) technology.

Accordingly, in the display device 100 according to embodiments of the present disclosure, a notch or camera hole for camera exposure does not have to be formed in the display panel 110, so that there is no reduction in area of the display area DA. Accordingly, the size of the bezel area can be reduced, design restrictions can be eliminated, and the degree of freedom in design can be increased.

Although the optical electronic devices 11 and 12 are hidden behind the display panel 110, the optical electronic devices 11 and 12 still need to receive light and perform a designated function thereof. In addition, although the optical electronic devices 11 and 12 are hidden behind the display panel 110 and are located overlapping with the display area DA, the normal image display function is still possible in optical areas OA1 and OA2 overlapping with optical electronic devices 11 and 12 in the display area DA. Also, because the first optical area OA1 can transmit/receive light, the image display characteristics in the first optical area OA1 can be different from the image display characteristics in the normal area NA.

Hereinafter, for convenience of explanation, the display device 100 according to the embodiments of the present disclosure includes only one optical area OA among the two optical areas OA1 and OA2. That is, it is assumed that the display device 100 has one optical area OA. However, the embodiments of the present disclosure are not limited thereto.

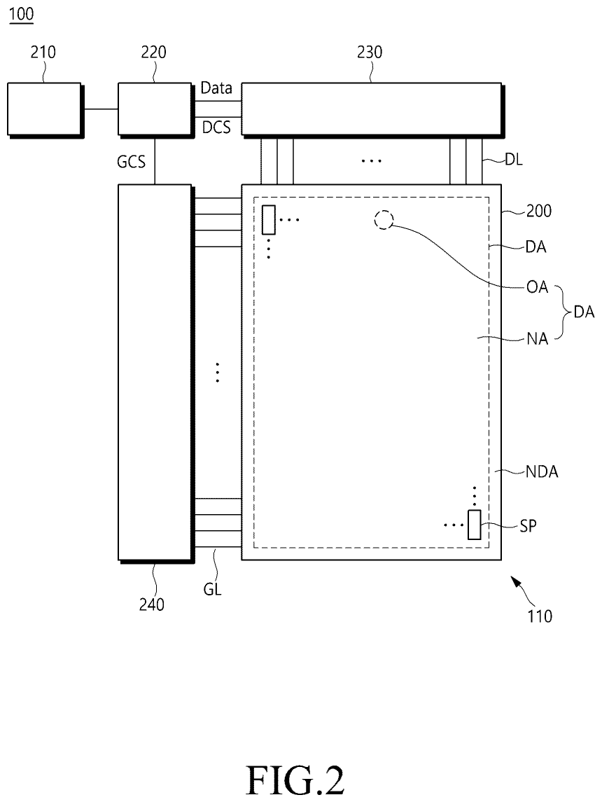

Next, FIG. 2 is a block diagram of a display device 100 according to embodiments of the present disclosure. Referring to FIG. 2, the display device 100 can include the display panel 110 and a display driving circuit as components for displaying an image. The display driving circuit drives the display panel 110, and includes a data driving circuit 230, a gate driving circuit 240 and a display controller 220.

The display panel 110 also includes a display area DA for displaying an image and a non-display area NDA where an image is not displayed. In particular, the non-display area NDA is outside the display area DA, and can also be referred to as a bezel area. All or part of the non-display area NDA can be visible from the front of the display device 100, or can be bent and not visible from the front of the display device 100.

Further, the display panel 110 includes a substrate 200 and a plurality of sub-pixels SP disposed on the substrate 200. Additionally, the display panel 110 includes various types of signal lines to drive the plurality of sub-pixels SP. In addition, the display device 100 can be a self-luminous display device in which the display panel 110 emits light on its own. However, the display device 100 according to the embodiments of the present disclosure is not limited to a self-luminous display device.

In addition, the data lines DL and the gate lines GL can cross each other. As shown, each of the data lines DL can be arranged to extend in a first direction and each of the gate lines GL can be arranged to extend in a second direction. Here, the first direction can be a column direction and the second direction can be a row direction. Alternatively, the first direction can be a row direction and the second direction can be a column direction.

Also, the data driving circuit 230 drives the data lines DL, and can output data signals to the data lines DL. Similarly, the gate driving circuit 240 drives the gate lines GL, and can output gate signals to the gate lines GL. In addition, the display controller 220 controls the data driving circuit 230 and the gate driving circuit 240 depending on the timing implemented in each frame, and can control the driving timing for the data lines DL and the driving timing of the gate lines GL.

Further, the display controller 220 (e.g., processor) can supply a data driving control signal DCS to the data driving circuit 230 to control the data driving circuit 220, and can supply a gate driving control signal GCS to the gate driving circuit 240 to control the gate driving circuit 230. The display controller 220 can also receive input image data from a host system 210 and supply image data to the data driving circuit 230 based on the input image data.

In addition, the data driving circuit 230 can receive image data in digital form from the display controller 240 and convert the received image data into analog data signals to output to a data ines DL. Also, the gate driving circuit 240 can receive a first gate voltage corresponding to the turn-on level voltage and a second gate voltage corresponding to the turn-off level voltage along with various gate driving control signals GCS, and can generate gate signals and supply the generated gate signals to the gate lines GL.

Further, the display device 100 can include a power supply circuit that supplies various types of power to the display driving circuit. Also, the display device 100 according to the embodiments of the present disclosure can be a mobile terminal such as a smart phone or tablet, or a monitor or television (TV) of various sizes, and is not limited thereto, and can be a display of various types and sizes capable of displaying information or images.

As described above, the display area DA in the display panel 110 can include a normal area NA and an optical area OA capable of displaying images. However, the normal area NA is an area that does not use a light-transmitting structure, and the optical area OA is an area where a light-transmitting structure is formed. The light-transmission structure where light can easily pass through the display and reach the optical devices 11 and 12 (so can be void of electrical componets, etc. that can block or reflect the light transmission to the optical devices 11 and 12).

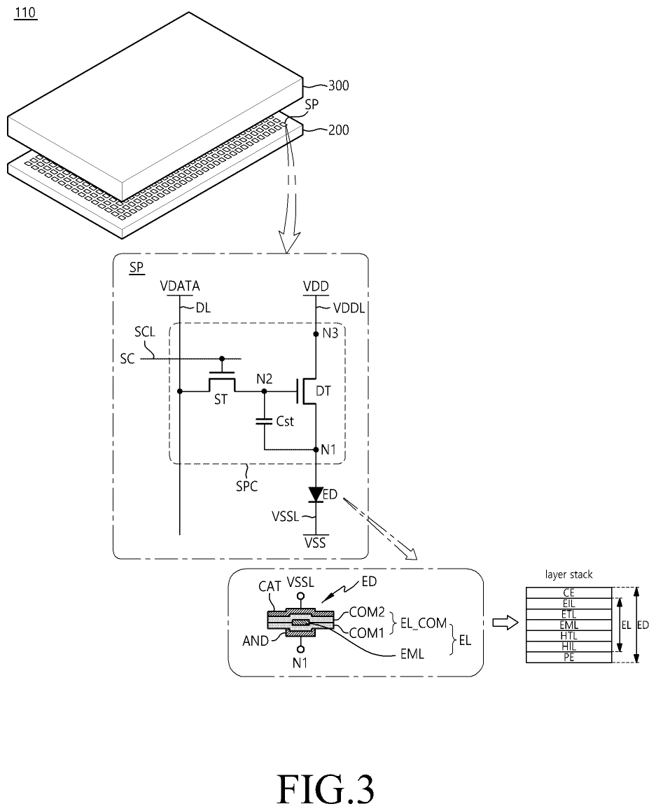

Next, FIG. 3 is an overview illustrating the display panel 110 according to embodiments of the present disclosure. Referring to FIG. 3, a plurality of sub-pixels SP are disposed in the display area DA including in both of the normal area NA and the optical area OA. Referring to FIG. 3, each of the sub-pixels SP can include a light emitting device ED and a sub-pixel circuit SPC configured to drive the light emitting device ED. As shown, the sub-pixel circuit SPC can include a driving transistor DT that supplies a driving current Id for driving the light emitting device ED, a scan transistor ST for transferring the data voltage VDATA to the driving transistor DT, and a storage capacitor Cst for maintaining a constant voltage during one frame.

In addition, the driving transistor DT can include a first node N1, a second node N2, and a third node N3. In particular, the first node N1 is electrically connected to the light emitting device ED, and the second node N2 is connected to the scan transistor ST. Also, the third node N3 is connected to a driving voltage line VDDL. The first node N1 is also electrically connected to the pixel electrode PE of the light emitting device ED. Further, the data voltage VDATA can be applied to the second node N2, and a driving voltage VDD can be applied to the third node N3. The first node N1 can also be a source node or a drain node, the second node N2 can be a gate node, and the third node N3 can be a drain node or a source node. Hereinafter, for convenience of explanation, in the driving transistor DT, the first node N1 is a source node, the second node N2 is a gate node, and the third node N3 is a drain node.

In addition, as shown in FIG. 3, the light emitting device ED can include a pixel electrode PE, an intermediate layer EL, and a common electrode CE. In particular, the pixel electrode PE is disposed in each sub-pixel SP. For example, the pixel electrode PE can be electrically connected directly or indirectly (via another transistor) to the first node N1 of the driving transistor DT of each sub-pixel SP. Also, the common electrode CE can be commonly disposed in the sub-pixels SP. For example, the common electrode CE can be electrically connected to a base voltage line VSSL. Thus, a base voltage VSS, which is a type of common driving voltage, can be applied to the common electrode CE through the base voltage line VSSL. Further, the pixel electrode PE can be an anode electrode, and the common electrode CE can be a cathode electrode. Alternatively, the pixel electrode PE can be a cathode electrode, and the common electrode CE can be an anode electrode. Hereinafter, for the pixel electrode PE is an anode electrode and the common electrode CE is a cathode electrode.

In addition, the intermediate layer EL can include an emission layer EML and a common intermediate layer EL_COM. In particular, the emission layer EML can be disposed in an emission area of each of the sub-pixels SP. For example, the emission layer EML can be disposed only in each of the sub-pixels SP. As another example, the emission layer EML can be commonly disposed in a plurality of sub-pixels SP. As still another example, the emission layer EML can be disposed only in the emission area. The emission layer EML can also be disposed in both the emission area and a non-emission area.

Further, the common intermediate layer EL_COM can be commonly disposed across a plurality of sub-pixels SP. The common intermediate layer EL_COM can also be commonly disposed over a plurality of emission areas EA and non-emission areas. In addition, the common intermediate layer EL_COM can include a first common intermediate layer COM1 and a second common intermediate layer COM2. The first common intermediate layer COM1 can be disposed between the pixel electrode PE and the emission layer EML, and can include at least one layer (e.g., an organic layer). Also, the second common intermediate layer COM2 can be disposed between the emission layer EML and the common electrode CE, and can include at least one layer (e.g., an organic layer).

For example, the first common intermediate layer COM1 can include a hole injection layer HIL and a hole transfer layer HTL. The second common intermediate layer COM2 can also include an electron transport layer ETL, an electron injection layer EIL, and the like. The hole injection layer can inject holes from the pixel electrode PE to the hole transport layer, the hole transport layer can transport holes to the emission layer EML, and the electron injection layer can inject electrons from the common electrode CE to the electron transport layer, and the electron transport layer can transport electrons to the emission layer EML. However, in addition to the hole injection layer HIL, hole transport layer HTL, electron injection layer EIL, and electron transport layer ETL described above, other layers can be further arranged in the first common intermediate layer COM1 and the second common intermediate layer COM2.

Each light emitting device ED can include an overlapping portion of a pixel electrode PE, an emission layer EML in the intermediate layer EL, and a common electrode CE. A predetermined emission area EA can be formed by each light emitting device ED. For example, the emission area EA can be defined as an area where the pixel electrode PE, the emission layer EML in the intermediate layer EL, and the common electrode CE overlap. Also, the light emitting device ED can be an organic light emitting diode (OLED) based on organic materials, an inorganic light emitting diode based on inorganic materials, or a quantum dot light emitting device. When the light emitting device ED is an organic light emitting diode, the intermediate layer EL in the light emitting device ED can include an organic layer containing an organic material.

Further, the scan transistor ST can be controlled on-off by a scan signal SC as a type of gate signal applied through the scan signal line SCL as a type of gate line GL, and can be electrically connected between the second node N2 of the driving transistor DT and the data line DL. The storage capacitor Cst can also be electrically connected between the first node N1 and the second node N2 of the driving transistor DT.

In addition, the sub-pixel circuit SPC can have a 2T(Transistor)-1C (Capacitor) structure including two transistors DT and ST and one capacitor Cst, as shown in FIG. 3, and can further include one or more transistors or one or more capacitors in some case. The storage capacitor Cst can also be an external capacitor intentionally designed outside the driving transistor DT rather than a parasitic capacitor (e.g., Cgs, Cgd) as an internal capacitor which can exist between the first node N1 and the second node N2 of the driving transistor DT. Each of the driving transistor DT and the scan transistor ST can be an n-type transistor or a p-type transistor.

Further, the circuit elements within each sub-pixel SP (in particular, light emitting devices EDs implemented with organic light emitting diodes (OLEDs) containing organic materials) can be vulnerable to external moisture or oxygen. Therefore, an encapsulation layer 300 is disposed on the display panel 110 to prevent oxygen from penetrating into the circuit elements (particularly, the light emitting device ED). The encapsulation layer 300 can be disposed to cover the light emitting devices ED.

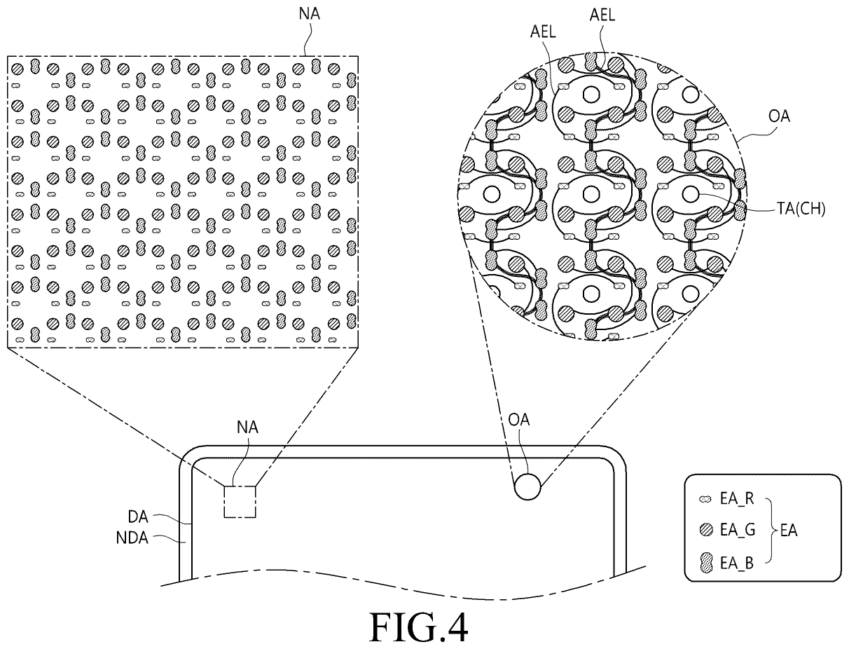

Next, FIG. 4 is an overview of a layout of sub-pixels SP in two areas NA and OA included in the display area DA of the display panel 110 according to embodiments of the present disclosure. Referring to FIG. 4, a plurality of sub-pixels SP can be arranged in each of the normal area NA and the optical area OA included in the display area DA. For example, the sub-pixels SP can include a red sub-pixel (Red SP) that emits red light, a green sub-pixel (Green SP) that emits green light, and a blue sub-pixel (Blue SP) that emits blue light. Accordingly, each of the normal area NA and the optical area OA can include an emission area EA of a red sub-pixel (Red SP), an emission area EA of a green sub-pixel (Green SP), and an emission area EA of a blue sub-pixel (Blue SP).

Referring to FIG. 4, the normal area NA does not include a light-transmitting structure, but does include emission areas EA. However, the optical area OA includes not only emission areas EA, but also a light-transmitting structure (TA). That is, the optical area OA can include emission areas EA and a transmission area TA. The transmission areas (TA) can also have different shapes to more naturally fit within the optical area. For example, as shown in FIG. 4, the transmission areas can comprises circle shapes areas that are free from light block elements such as transistors, electrodes etc. The transmission areas can also be disposed evenly throughout the optical area to provide sufficient light transmission areas so the light can easily pass through the display to the optical devices behind the display. The transmission areas can also have random shapes suited to match surrounding shapes of the anode extension lines traversing through the optical area.

In more detail, the emission areas EA and the transmission area TA can be distinguished depending on whether light is transmitted. That is, the emission areas EA can be areas that are not light-transmittable, and the transmission area TA can be areas that are light-transmittable. In addition, the emission areas EA and the transmission area TA can be distinguished depending on whether a specific metal layer CE is formed. For example, a common electrode CE can be formed in the emission areas EA, but a common electrode CE is not formed in the transmission area TA. A light shield layer can also be formed in the emission areas EA, but not be formed in the transmission area TA.

Further, the transmission area TA can be arranged so as not to overlap with the light emitting device ED and the pixel circuit SPC. Thus, the optical electronic device 11 can perform a predefined operation using light transmitted through the transmission area TA. Because the optical area OA includes the transmission area TA, the optical area OA can be an area through which light can be transmitted.

Referring to FIG. 4, an anode extension line AEL extended from a pixel circuit SPC arranged in an external area of the optical area OA can be disposed in the optical area OA. The anode extension line AEL can electrically connect the pixel circuit SPC arranged in the outer area of the optical area OA and the light emitting device ED arranged in the optical area OA.

In addition, the anode extension line AEL can be arranged so that a plurality of light emitting devices ED disposed in the optical area OA are electrically connected at the same time. Referring to FIG. 4, the emission area (EA of Red SP) of the red sub-pixel can be electrically connected in units of four through the anode extension line AEL. Here, the meaning that the emission area EA is electrically connected can be the same as the meaning that the sub-pixel SP included in the emission area EA is electrically connected. In addition, the emission area (EA of Green SP) of the green sub-pixel can be electrically connected in units of four through the anode extension line AEL. Also, the emission areas of the blue sub-pixels (EA of Blue SP) can be electrically connected in units of four through an anode extension line AEL.

Further, the anode extension line AEL connecting the emission areas of the red sub-pixels (EA of Red SP), the emission areas of the green sub-pixels (EA of Green SP), and the emission areas of the blue sub-pixels (EA of Blue SP) in units of four can be a plurality of line bundles that are separated from each other. In addition, the emission areas of the red sub-pixels (EA of Red SP), the emission areas of the green sub-pixels (EA of Green SP), and the emission areas of the blue sub-pixels (EA of Blue SP) are shown as being connected in units of four, but is not limited thereto. For example, two or more emission areas of the sub-pixels can be connected.

In addition, as illustrated in FIG. 4, in the embodiments of the present disclosure, the transmission area TA can also be referred to as a transparent area, and a transmittance can also be referred to as a transparency. Further, the optical area OA is assumed to be located at the top of the display area DA of the display panel 110. Also, the anode extension line AEL can electrically connect the pixel circuit SPC located outside the optical area OA and the light emitting device ED located in the optical area OA.

Meanwhile, the pixel circuit SPC located in the outer area of the optical area OA to which the light emitting device ED located in the optical area OA is connected through the anode extension line AEL can be located in an optical bezel area OBA. The optical bezel area OBA can be a region located between the optical area OA and the normal area NA to surround the optical area OA.

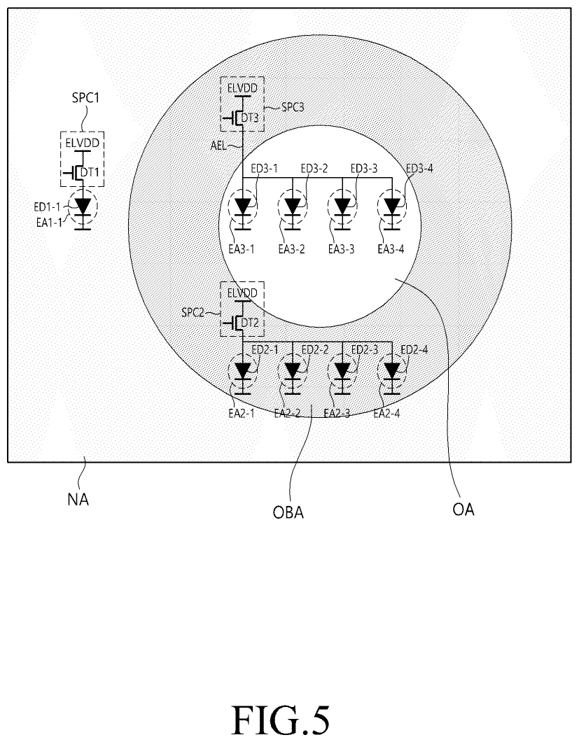

Next, FIG. 5 is an overview illustrating light emitting devices ED1-1, ED2-1, ED2-2, ED2-3, ED2-4, ED3-1, ED3-2, ED3-3 and ED3-4 arranged in a normal area NA, an optical bezel area OBA, and an optical area OA in a display panel 110 according to embodiments of the present disclosure, and pixel circuits SPC1, SPC2 and SPC3 for driving the light emitting devices ED1-1, ED2-1, ED2-2, ED2-3, ED2-4, ED3-1, ED3-2, ED3-3 and ED3-4. Each of the pixel circuits SPC1, SPC2 and SPC3 can include transistors DT and ST and storage capacitors Cst, as in FIG. 3. However, for convenience of explanation, each of the pixel circuits SPC1, SPC2 and SPC3 is simply expressed as a driving transistor DT1, DT2 and DT3.

Referring to FIG. 5, the normal area NA, the optical area OA, and the optical bezel area OBA can have structural differences as well as positional differences. As a structural difference, the pixel circuits SPC1, SPC2 and SPC3 can be arranged in the optical bezel area OBA and the normal area NA, but the pixel circuits can be not arranged in the optical area OA. That is, the transistors DT1, DT2 and DT3 can be arranged in the optical bezel area OBA and the normal area NA, but the transistors are not arranged in the optical area OA.

In addition, the transistors and storage capacitors included in the pixel circuits SPC1, SPC2 and SPC3 can be configurations capable of reducing the transmittance. Accordingly, because the pixel circuits SPC1, SPC2 and SPC3 are not disposed in the optical area OA, the transmittance of the optical area OA can be further increased. Also, the pixel circuits SPC1, SPC2 and SPC3 can be disposed only in the normal area NA and the optical bezel area OBA, but the light emitting devices ED1-1, ED2-1, ED2-2, ED2-3, ED2-4, ED3-1, ED3-2, ED3-3 and ED3-4 can be disposed in all of the normal area NA, the optical bezel area OBA, and the optical area OA.

Referring to FIG. 5, the 3-1, 3-2, 3-3, 3-4 light emitting devices ED3-1, ED3-2, ED3-3 and ED3-4 can be disposed in the optical area OA, but a third pixel circuit SPC3 for driving the 3-1, 3-2, 3-3, 3-4 light emitting devices ED3-1, ED3-2, ED3-3 and ED3-4 is not disposed in the optical area OA. As shown, the third pixel circuit SPC3 for driving the 3-1, 3-2, 3-3, 3-4 light emitting devices ED3-1, ED3-2, ED3-3 and ED3-4 disposed in the optical area OA can be arranged in the optical bezel area OBA rather than the optical area OA.

Hereinafter, the normal area NA, the optical area OA, and the optical bezel area OBA are described in more detail.

Referring to FIG. 5, the emission areas EA included in the display panel 110 according to the embodiments of the present disclosure can include a 1-1 emission area EA1-1, a 2-1 emission area EA2-1, a 2-2 emission area EA2-2, a 2-3 emission area EA2-3, a 2-4 emission area EA2-4, a 3-1 emission area EA3-1, a 3-2 emission area EA3-2, a 3-3 emission area EA3-3, and a 3-4 emission area EA3-4. Here, the 3-1 emission area EA3-1, the 3-2 emission area EA3-2, the 3-3 emission area EA3-3, and the 3-4 emission area EA3-4 can be included in the optical area OA, the 2-1 emission area EA2-1, the 2-2 emission area EA2-2, the 2-3 emission area EA2-3, and the 2-4 emission area EA2-4 can be included in the optical bezel area OBA, and the 1-1 emission area EA1-1 can be included in the normal area NA.

Hereinafter, it is assumed that the 1-1 emission area EA1-1, the 2-1 emission area EA2-1, the 2-2 emission area EA2-2, the 2-3 emission area EA2-3, the 2-4 emission area EA2-), the 3-1 emission area EA3-1, the 3-2 emission area EA3-2, the 3-3 emission area EA3-3, and the 3-4 emission area EA3-4 can be emission areas of the same color. As shown in FIG. 5, the display panel 110 according to the embodiments of the present disclosure can include a 3-1 light emitting device ED3-1 disposed in an optical area OA and having the 3-1 emission area EA3-1, a 3-2 light emitting device ED3-2 having the 3-2 emission area EA3-2, a 3-3 light emitting device ED3-3 having the 3-3 emission area EA3-3, and a 3-4 light emitting device ED3-4 having the 3-4 emission area EA3-4.

In addition, referring to FIG. 5, the display panel 110 can include a 2-1 light emitting device ED2-1 disposed in an optical bezel area OBA and having the 2-1 emission area EA2-1, a 2-2 light emitting device ED2-2 having the 2-2 emission area EA2-2, a 2-3 light emitting device ED2-3 having the 2-3 emission area EA2-3, and a 2-4 light emitting device ED2-4 having the 2-4 emission area EA2-4.

As shown in FIG. 5, the display panel 110 can further include a first pixel circuit SPC1 configured to drive the 1-1 light emitting device ED1-1, a second pixel circuit SPC2 configured to drive the 2-1 light emitting device ED2-1, the 2-2 light emitting device ED2-2, the 2-3 light emitting device ED2-3, and the 2-4 light emitting device ED2-4, and a third pixel circuit SPC3 configured to drive the 3-1 light emitting device ED3-1, the 3-2 light emitting device ED3-2, the 3-3 light emitting device ED3-3, and the 3-4 light emitting device ED3-4.

In this instance, the structure in which the second pixel circuit SPC2 drives four light emitting devices ED2-1, ED2-2, ED2-3 and ED2-4 and the third pixel circuit SPC3 drives four light emitting devices ED3-1, ED3-2, ED3-3 and ED3-4 can be referred to as a 1:4 circuit connection method. That is, one pixel circuit SPC driving four light emitting devices ED can be called a 1:4 circuit connection method.

In addition, the 1:4 circuit connection method is only an example for the convenience of explanation and is not limited thereto. For example, the structure in which one pixel circuit SPC drives N light emitting devices ED can be referred to as a 1:N (N is a natural number greater than or equal to 2) circuit connection method. According to the 1:N circuit connection method, the first pixel circuit SPC1 disposed in the optical bezel area OBA can simultaneously drive two or more light emitting devices ED arranged in the optical area OA.

Referring to FIG. 5, the first pixel circuit SPC1 can include a first driving transistor DT1, the second pixel circuit SPC2 can include a second driving transistor DT2, and the third pixel circuit SPC3 can include a third driving transistor DT3. As shown, the second pixel circuit SPC2 can be disposed in the optical bezel area OBA where the corresponding second light emitting device ED2 is disposed, and the first pixel circuit SPC1 can be disposed in the normal area NA where the corresponding 1-1 light emitting device ED1-1 is disposed.

Referring to FIG. 5, the third pixel circuit SPC3 is not disposed in the optical area OA where the corresponding 3-1 light emitting device ED3-1, the 3-2 light emitting device ED3-2, the 3-3 light emitting device ED3-3, and the 3-4 light emitting device ED3-4 are disposed, but is disposed in the optical bezel area OBA located outside the optical area OA. Accordingly, the transmittance of the optical area OA can be increased.

As shown in FIG. 5, the display panel 110 can further include an anode extension line AEL that electrically connects the third pixel circuit SPC3 disposed in the optical bezel area OBA and the 3-1 light emitting device ED3-1, the 3-2 light emitting device ED3-2, the 3-3 light emitting device ED3-3, and the 3-4 light emitting device ED3-4 disposed in the optical area OA. In particular, the anode extension line AEL can electrically extend the anode electrode AE of each of the 3-1 light emitting device ED3-1, the 3-2 light emitting device ED3-2, the 3-3 light emitting device ED3-3, and the 3-4 light emitting device ED3-4 to a first node N1 of the third driving transistor DT3 in the third pixel circuit SPC3. That is, the anode extension line AEL can electrically connect the pixel circuit SPC disposed in the optical bezel area OBA and a plurality of light emitting devices ED disposed in the optical area OA.

As described above, the third pixel circuit SPC3 for driving the 3-1 light emitting device ED3-1, the 3-2 light emitting device ED3-2, the 3-3 light emitting device ED3-3, and the 3-4 light emitting device ED3-4 disposed in the optical area OA can be arranged in the optical bezel area OBA instead of the optical area OA. This structure can also be referred to as an anode extension structure.

If the display panel 110 has an anode extension structure, all or part of the anode extension line AEL can be arranged in the optical area OA, and the anode extension line AEL can include transparent wiring. Accordingly, even if the anode extension line AEL connecting the third pixel circuit SPC3 and the 3-1 light emitting device ED3-1, the 3-2 light emitting device ED3-2, the 3-3 light emitting device ED3-3, and the 3-4 light emitting device ED3-4 is arranged in the optical area OA, it is possible to prevent the transmittance of the optical area OA from being reduced.

As described above, the third pixel circuit SPC3 disposed in the optical bezel area OBA can drive the four light emitting devices ED3-1, ED3-2, ED3-3and ED3-4 disposed in the optical area OA. This circuit connection method can be referred to as a one-to-four (1:4) circuit connection method. However, the one-to-four (1:4) circuit connection method is only an example and is not limited thereto. For example, the third pixel circuit SPC3 disposed in the optical bezel area OBA can drive one light emitting device ED disposed in the optical area OA. Alternatively, the third pixel circuit SPC3 disposed in the optical bezel area OBA can drive a plurality of light emitting devices ED disposed in the optical area OA.

For example, if the third pixel circuit SPC3 disposed in the optical bezel area OBA drives one light emitting device ED disposed in the optical area OA, the number of pixel circuits SPC disposed in the optical bezel area OBA can significantly increase. Therefore, the structure of the optical bezel area OBA can become complicated, and the aperture area of the optical bezel area OBA can decrease. Hereinafter, in the present disclosure, the aperture area can also be referred to as the emission area, and can also be referred to as the open ratio or the aperture ratio.

As described above, the third pixel circuit SPC3 can have a 1:4 circuit connection method in which the four light emitting devices ED3-1, ED3-2, ED3-3 and ED3-4 are driven. Accordingly, although the display panel 110 has an anode extension structure, the number of pixel circuits SPC disposed in the optical bezel area OBA can be reduced, thereby increasing the opening and emission area of the optical bezel area OBA.

Referring to FIG. 5, the four light emitting devices ED3-1, ED3-2, ED3-3 and ED3-4 driven together by the third pixel circuit SPC3 disposed in the optical bezel area OBA can be light emitting devices emitting light of the same color or same wavelength band, and can be light emitting devices adjacent in the row direction or the column direction. As shown, the anode extension line AEL can connect the third pixel circuit SPC3 disposed in the optical bezel area OBA to the 3-1 light emitting device ED3-1, the 3-2 light emitting device ED3-2, the 3-3 light emitting device ED3-3, and the 3-4 light emitting device ED3-4 disposed in the optical area OA.

As shown in FIG. 5, because the light emitting devices ED arranged in the optical area OA and the optical bezel area OBA are connected to the pixel circuit SPC in a 1:4 circuit connection manner, if an arbitrary image is displayed in the normal area NA, the optical area OA, and the optical bezel area OBA, different images can be displayed for each area. In particular, when displaying a character-based text image, a difference can occur between the normal area NA and the optical area OA.

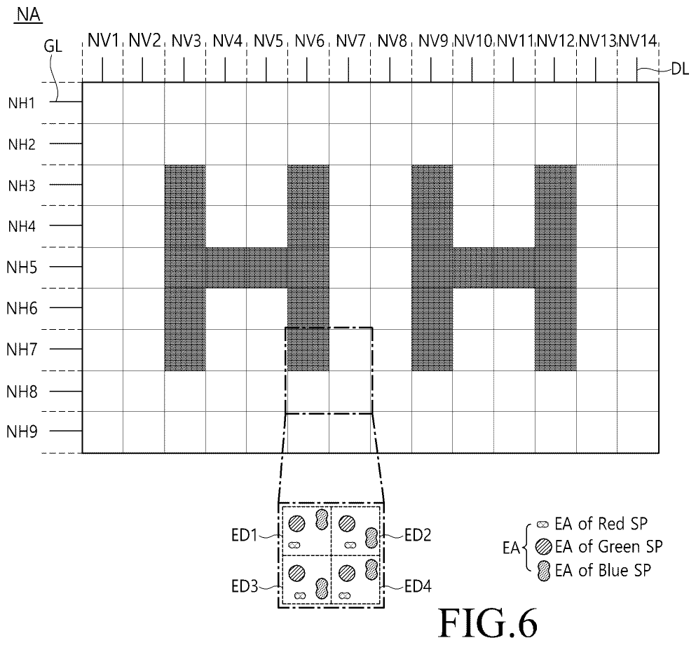

Next, FIG. 6 is an overview illustrating a matrix of light emitting devices ED supplied with a driving current Id when the text “HH” is displayed in a normal area NA according to an embodiment of the present disclosure. Referring to FIG. 6, the normal area NA can include a matrix of light emitting devices ED arranged in 9 rows and 14 columns. The matrix of light emitting devices ED shown in FIG. 6 can represent a portion of the normal area NA.

In each matrix cell of the normal area NA, one emission area of a red sub-pixel (EA of Red SP), one emission area of a green sub-pixel (EA of Green SP), and one emission area of a blue sub-pixel (EA of Blue SP) can be disposed. However, this is only an example for the convenience of explanation, and the type and number of emission areas EA can be modified in various ways in each matrix cell.

For convenience of explanation, hereinafter, it is assumed that one emission area of a red sub-pixel (EA of Red SP), one emission area of a green sub-pixel (EA of Green SP), and one emission area of a blue sub-pixel (EA of Blue SP) are arranged in each matrix cell. For example, the meaning of the explanation that a driving current Id is supplied to a light emitting device ED in a first row and a first column can be the same as the meaning that a driving current Id is supplied to a light emitting device ED corresponding to a emission area of a red sub-pixel (EA of Red SP), a light emitting device ED corresponding to a emission area of a green sub-pixel (EA of Green SP), and a light emitting device ED corresponding to a emission area of a blue sub-pixel (EA of Blue SP) arranged in first row and the first column.

That is, hereinafter, the meaning of the light emitting device ED arranged in the first row and the first column can refer to all of the light emitting device ED corresponding to the emission area (EA of Red SP) of the red sub-pixel, the light emitting device ED corresponding to the emission area (EA of Green SP) of the green sub-pixel, and the light emitting device ED corresponding to the emission area (EA of Blue SP) of the blue sub-pixel arranged in the first row and the first column.

Referring to FIG. 6, a data line DL and a gate line GL can be arranged in each row and column of the normal area NA of 9 rows and 14 columns. That is, a gate line GL can be arranged in each of the 9 rows, and a data line DL can be arranged in each of the 14 columns.

The meaning of the description that data lines DL or gate lines GL are arranged in a matrix can be the same as the meaning that light emitting devices ED are arranged according to each matrix, and light emitting devices ED arranged according to each matrix can be electrically connected to the data lines DL and gate lines GL arranged according to each matrix. In other words, each gate line GL and data line DL can be electrically connected to all light emitting devices ED corresponding to each matrix. Each light emitting device ED can receive a driving current Id through the gate line GL and data line DL corresponding to each.

Referring to FIG. 6, if the text of “HH” is displayed in a normal area NA having 9 rows and 14 columns, each stroke of the “HH” text can be displayed to correspond to one column or one row. For example, in the column direction, a driving current Id can be applied to the light emitting devices ED arranged from a third row NH3 to a seventh row NH7 of a third column NV3, from a third row NH3 to a seventh row NH7 of a sixth column NH6, from a third row NH3 to a seventh row NH7 of a ninth column NV9, and from a third row NH3 to a seventh row NH7 of the 12-th column NV12.

In addition, in the row direction, a driving current Id can be applied to the light emitting devices ED arranged from a third column NV3 to a sixth column NV6 of a fifth row NH5, and from a ninth column NV9 to a 12-th column NV12 of the fifth row NH). Meanwhile, the first light emitting device ED1, the second light emitting device ED2, the third light emitting device ED3, and the fourth light emitting device ED4 shown in FIG. 6 can be light emitting devices ED arranged adjacent to each other. Referring to FIG. 6, the first light emitting device ED1 can be disposed in the sixth column NV6 and the seventh row NH7 of the normal area NA. The second light emitting device ED2 can be disposed in the seventh column NV7 and the seventh row NH7 of the normal area NA. The third light emitting device ED3 can be disposed in the sixth column NV6 and the eighth row NH8 of the normal area NA. The fourth light emitting device ED4 can be disposed in the seventh column NV7 and the eighth row NH8 of the normal area NA.

That is, the second light emitting device ED2 can be disposed on the right side of the first light emitting device ED1, the third light emitting device ED3 can be disposed below the first light emitting device ED1, and the fourth light emitting device ED4 can be disposed on the lower right side of the first light emitting device ED1. In this instance, data lines DL and gate lines GL corresponding to the light emitting devices ED1, ED2, ED3 and ED4 can be electrically connected to each of the light emitting devices ED1, ED2, ED3 and ED4. Therefore, if the text “HH” is displayed in the normal area NA shown in FIG. 6, the driving current Id can be applied to the first light emitting device ED1 to which the driving current Id should be applied, and the second light emitting device ED2, the third light emitting device ED3, and the fourth light emitting device ED4 cannot be supplied with the driving current Id because they are driven independently of the first light emitting device ED1.

In this instance, since one stroke of the “HH” text in the normal area NA is displayed from the light emitting devices ED arranged in one row or one column, a thickness of the stroke in the normal area NA can be 1.

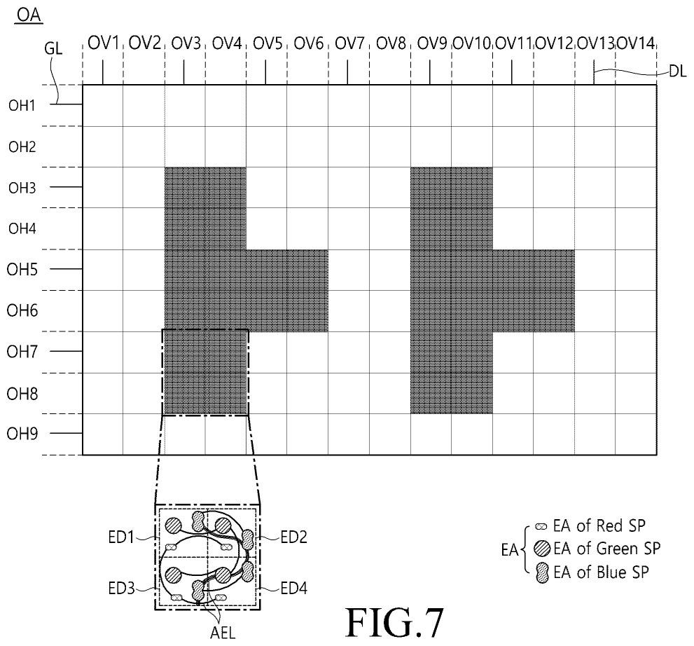

Next, FIG. 7 is an overview illustrating a matrix of light emitting devices ED supplied with a driving current Id when displaying the “HH” text in the optical area OA according to an embodiment of the present disclosure. Referring to FIG. 7, the optical area OA can include a matrix of light emitting devices ED arranged in 9 rows and 14 columns. The matrix of light emitting devices ED shown in FIG. 7 can represent a portion of the optical area OA.

As shown, data lines DL and gate lines GL can be arranged in odd rows and odd columns of the optical area OA of 9 rows and 14 columns. In addition, data lines DL and gate lines GL cannot be arranged in even rows and even columns of the optical area OA. In other words, gate lines GL can be arranged in only five rows among the nine rows, and data lines DL can be arranged in only seven columns among the 14 columns.

Also, number of data lines DL and gate lines GL arranged in the optical area OA shown in FIG. 7 is only an example and is not limited thereto, and can be arranged in various ways depending on the circuit connection method. Referring to FIG. 7, the light emitting devices ED in the optical area OA can be arranged according to the 1:4 circuit connection method. That is, each of the four light emitting devices ED can be electrically connected through the anode extension line AEL so that the driving current Id can be applied at once.

As shown in FIG. 7, the first light emitting device ED1, the second light emitting device ED2, the third light emitting device ED3, and the fourth light emitting device ED4 can be electrically connected by the anode extension line AEL. Here, the second light emitting device ED2 can be the light emitting device ED adjacent to the right side of the first light emitting device ED1. Also, the third light emitting device ED3 can be a light emitting device ED adjacent to the lower side of the first light emitting device ED1, and the fourth light emitting device ED4 can be a light emitting device ED adjacent to the lower right side of the first light emitting device ED1. Therefore, if a driving current Id is applied to the first light emitting device ED1, the driving current Id can also be applied to the second light emitting device ED2, the third light emitting device ED3, and the fourth light emitting device ED4 that are electrically connected to the first light emitting device ED1 by the anode extension line AEL.

In this instance, the first light emitting device ED1, the second light emitting device ED2, the third light emitting device ED3, and the fourth light emitting device ED4 are electrically connected to each other, and can output light of the same wavelength band. Here, the meaning of outputting light of the same wavelength band can be the same as the meaning that the light emitting devices ED corresponding to the emission areas (EA of Red SP) of each red sub-pixel included in each light emitting device ED1, ED2, ED3 and ED4, the light emitting devices ED corresponding to the emission areas (EA of Green SP) of the green sub-pixel included in each light emitting device ED1, ED2, ED3 and ED4, and the light emitting devices corresponding to the emission areas (EA of Blue SP) of the blue sub-pixel included in each light emitting device ED1, ED2, ED3 and ED4 are electrically connected to each other and can output light of the same wavelength band.

For example, when a driving current Id is applied to a light emitting device ED arranged in a seventh row OH7 and a third column OV3, the driving current Id can also be applied to the light emitting devices arranged in the seventh row OH7 and a fourth column OV4, an eighth row OH8 and the third column OV3, and the eighth row OH8 and the fourth column OV4.

Therefore, referring to FIG. 7, when the “HH” text is displayed in the optical area OA having 9 rows and 14 columns, each stroke of the “HH” text can be displayed to correspond to two columns or two rows. For example, in the column direction, a driving current Id can be applied to the light emitting device ED arranged in the third column OV3 and the third row OH3, the third column OV3 and a fifth row OH5, the third column OV3 and a seventh row OH7, a ninth column OV9 and the third row OH3, the ninth column OV9 and the fifth row OH5, and the ninth column OV9 and the seventh row OH7 where the data line DL and the gate line GL intersect.

Also, since the light emitting devices ED arranged in the optical area OA follow the 1:4 circuit connection method, the driving current Id can also be applied to the light emitting devices ED arranged in the third row OH3 of the fourth column OV4, the third row OH3 of the third column OV3, the fourth row OH4 of the third column OV3, and the fourth row OV4 of the fourth column OV4, which are electrically connected to a light emitting device ED arranged in the third column OV3 and third row OH3.

Similarly, the driving current Id can also be applied to the light emitting devices ED arranged in the fifth row OH5 of the third column OV3, the sixth row OH6 of the third column OV3, and the sixth row OH6 of the fourth column OV4 that are electrically connected to the light emitting devices ED arranged in the third column OV3 and fifth row OH5. In addition, the driving current Id can be applied to the light emitting devices ED arranged in the fourth column OV4 and the seventh row OH7, the third column OV3 and eighth row OH8, and the fourth column OV4 and eighth row OH8, which are electrically connected to the light emitting devices ED arranged in the third column OV3 and seventh row OH7.

Similarly, the driving current Id can be applied to the light emitting devices ED arranged in the tenth column OV10 and third row OH3, the ninth column OV9 and fourth row OH4, and the tenth column OV10 and fourth row OH4 which are electrically connected to the light emitting devices ED arranged in the ninth column OV9 and third row OH3. Also, the driving current Id can be applied to the light emitting devices ED arranged in the tenth column OV10 and fifth row OH5, the ninth column OV9 and sixth row OH6, and the tenth column OV10 and sixth row OH6 which are electrically connected to the light emitting devices ED arranged in the ninth column OV9 and fifth row OH5.

Further, the driving current Id can be applied to the light emitting devices ED arranged in the tenth column OV10 and seventh row OH7, the ninth column OV9 and eighth row OH8, and the tenth column OV10 and eighth row OH8 which are electrically connected to the light emitting devices ED arranged in the ninth column OV9 and seventh row OH7. In addition, in a row direction, a driving current Id can be applied to the light emitting devices ED arranged in the third column OV3 and fifth row OH5, the fifth column OV5 and fifth row OH5, the ninth column OV9 and fifth row OH5, and the eleventh column OV11 and fifth row OH5 where the data line DL and the gate line GL intersect.

In this instance, because the light emitting devices ED arranged in the optical area OA follow the 1:4 circuit connection method, a driving current Id can also be applied to the light emitting devices ED arranged in the fourth column OV4 and fifth row OH5, the third column OV3 and sixth row OH6, and the fourth column OV4 and sixth row OH6 that are electrically connected to the light emitting devices ED arranged in the third column OV3 and fifth row OH5. Similarly, a driving current Id can be applied to the light emitting devices ED arranged in the sixth column OV6 and fifth row OH5, the fifth column OV5 and sixth row OH6, and the sixth column OV6 of the sixth row OH6, which are electrically connected to the light emitting devices ED arranged in the fifth row OH5 and the fifth column OV5.

Also, a driving current Id can be applied to the light emitting devices ED arranged in the tenth column OV10 and fifth row OH5, the ninth column OV9 and sixth row OH6, and the tenth column OV10 and sixth row OH6, which are electrically connected to the light emitting devices ED arranged in the ninth column OV9 and fifth row OH5. In addition, the driving current Id can be applied to the light emitting devices ED arranged in the twelfth column OV12 and fifth row OH5, the eleventh column OV11 and sixth row OH6, and the twelfth column OV12 and sixth row OH6, which are electrically connected to the light emitting devices ED arranged in the eleventh column OV11 and fifth row OH5.

In addition, because one stroke of the text “HH” in the optical area OA is displayed from the light emitting devices ED arranged in two rows or two columns, the thickness of the stroke in the normal area NA can be 2. Accordingly, when the same text displayed in the normal area NA is displayed in the optical area OA, the thickness of the text stroke displayed in the optical area OA can be greater than the thickness of the text stroke displayed in the normal area NA.

Referring to FIG. 7, in order to display the text “HH” in the optical area OA, the driving current Id is applied to the light emitting devices ED arranged from the third row OH3 to the seventh row OH7 of the sixth column OV6, but since the data line DL is not arranged in the sixth column OV6 of the optical area OA, the driving current Id cannot be applied to the light emitting devices ED arranged in the sixth column OV6 of the optical area OA. This can also be the same in the twelfth column OV12. Therefore, when displaying the text “HH” in the optical area OA, a loss of strokes can occur.

Because the light emitting devices ED are arranged in the optical area OA through a 1:4 circuit connection method to secure an aperture ratio, there can be a problem in which a loss of strokes can occur in a matrix where the data line DL and the gate line GL are not arranged. Therefore, in order to prevent loss of text strokes displayed in the optical area OA, a driving current Id can be supplied to an adjacent light emitting device ED of a matrix in which a data line DL or a gate line GL is not arranged.

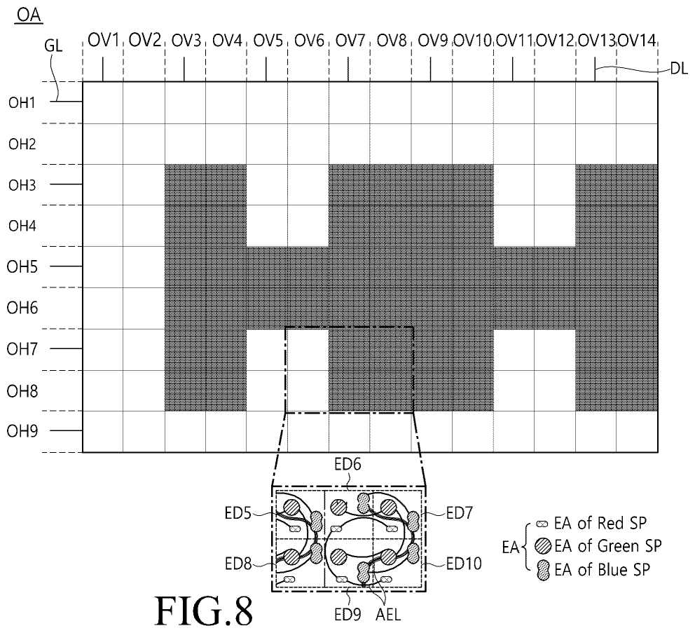

Next, FIG. 8 is an overview illustrating a matrix of light emitting devices ED supplied with a driving current when displaying “HH” text in the optical area OA without loss of strokes according to an embodiment of the present disclosure. Referring to FIG. 8, the optical area OA can include a matrix of light emitting devices ED arranged in 9 rows and 14 columns, similar to FIG. 7. The matrix of light emitting devices ED shown in FIG. 8 can represent a part of the optical area OA.

The optical area OA shown in FIG. 8 can be applied with a 1:4 circuit connection method, similar to the optical area OA shown in FIG. 7. Therefore, the matrix of light emitting devices ED supplied with the driving current Id in the optical area OA shown in FIG. 7 can be directly included in the matrix of light emitting devices ED supplied with the driving current Id in the optical area OA shown in FIG. 8. Also, the matrix of light emitting devices ED supplied with the driving current Id of FIG. 7 included in FIG. 8 will be omitted from description.

In FIG. 7, because the data lines DL are not arranged in the sixth column OV6 and the twelfth column OV12 of the optical area OA, the driving current Id is not applied to the light emitting devices ED arranged in the sixth column OV6 and the twelfth column OV12 of the optical area OA, so that there can occur a loss of strokes of text image.

Referring to FIG. 8, in order to prevent stroke loss due to the driving current Id not being applied to the light emitting devices ED arranged in the sixth column OV6 and the 12-th column OV12, the driving current Id can be applied to the adjacent light emitting devices ED. Specifically, because the data line DL is not arranged in the third row OH3 to the sixth row OH6 of the sixth column OV6 of the optical area OA, and the third row OH3 to the sixth row OH6 of the 12-th column OV12, the driving current Id cannot be applied.

Therefore, the driving current Id can be applied to the third row OH3 to the sixth row OH6 of the seventh column OV7 which are adjacent to the third row OH3 to the sixth row OH6 of the sixth column OV6. In addition, the driving current Id can be applied to the third row OH3 to the sixth row OH6 of the 13-th column OV13 which are adjacent to the third row OH3 to the sixth row OH6 of the twelfth column OV12. That is, the driving current Id can be applied to the light emitting device ED adjacent to the right and bottom of the light emitting device ED on which the text should be displayed. This can operate regardless of whether the data line DL and the gate line GL are connected to the light emitting device ED on which the text should be displayed.

Specifically, compared to a matrix of the normal area NA shown in FIG. 6, because the light emitting device ED for displaying the text image is in the third row OH3 and third column OV3 of the optical area OA, the driving current is applied to the third row OH3 and third column OV3, and at the same time, the driving current Id can be applied to the light emitting device ED arranged in the fourth column OV4 and third row OH3, and the third column OV3 and fourth row OH4, which are adjacent to the third column OV3 and third row OH3 to the right and lower sides.

In this instance, the data line DL is not electrically connected to the light emitting device ED in the fourth column OV4 and third row OH3, and therefore, the driving current Id cannot be applied through the data line DL arranged in the fourth column OV4. However, because the light emitting device ED of the fourth column OV4 and third row OH3 is electrically connected to the light emitting device ED of the third column OV3 and third row OH3 through the anode extension line AEL, the driving current Id can be applied as a result.

Meanwhile, because the data line DL is not electrically connected to the light emitting device ED of the sixth column OV6 and third row OH3, which is the light emitting device ED on which text should be displayed, the driving current Id cannot be applied to the light emitting device ED of the sixth column OV6 and third row OH3. However, because the driving current Id is controlled to flow to the light emitting device ED adjacent to the right and bottom of the light emitting device ED on which the text should be displayed, the driving current Id can flow to the light emitting device ED arranged in the seventh column OV7 and third row OH3 through the signals of the data line DL and the gate line GL corresponding to the seventh column OV7 and third row OH3.

In this instance, because the light emitting device ED arranged in the seventh column OV7 and third row OH3 is connected to the light emitting device ED arranged in the eighth column OV8 and third row OH3, and the light emitting device ED arranged in the seventh column OV7 and fourth row OH4 through the anode extension line AEL, so that the driving current Id can also flow to the light emitting device ED arranged in the eighth column OV8 and third row OH3, and the light emitting device ED arranged in the seventh column OV7 and fourth row OH4.

In addition, the configuration of driving current Id flowing to a light emitting device ED arranged in the seventh column OV7 and third row OH3 and then flowing to a light emitting device ED of an adjacent matrix can be applied to a state in which driving current Id flows to a light emitting device ED of the adjacent matrix of each of the light emitting device ED arranged in the seventh column OV7 and fifth row OH5, a light emitting device ED arranged in the seventh column OV7 and seventh row OH7, a light emitting device ED arranged in the 13-th column OV13 and third row OH3, a light emitting device ED arranged in the 13-th column OV13 and fifth row OH5, and a light emitting device ED arranged in the 13-th column OV13 and seventh row OH7. In this instance, the application of a driving current Id to an adjacent light emitting device ED can be controlled through a display controller 220 included in the display device 100.

Referring to FIG. 8, the matrix of the optical area OA can include a fifth light emitting device ED5 arranged in the sixth column OV6 and seventh row OH7, a sixth light emitting device ED6 arranged in the seventh column OV7 and seventh row OH7, a seventh light emitting device ED7 arranged in the eighth column OV8 and seventh row OH7, an eighth light emitting device ED8 arranged in the sixth column OV6 and eighth row OH8, a ninth light emitting device ED9 arranged in the seventh column OV7 and eighth row OH8, and a tenth light emitting device ED10 arranged in the eighth column OV8 and eighth row OH8.

Further, the sixth light emitting device ED6, the seventh light emitting device ED7, the ninth light emitting device ED9, and the tenth light emitting device ED10 can be electrically connected to each other so as to output light of the same wavelength band.

As described above, when displaying the “HH” text in the optical area OA, the fifth light emitting device ED5 to which the driving current Id should be applied is not connected to the data line DL, so the driving current Id is not applied, and the sixth light emitting device ED6 adjacent to the fifth light emitting device ED5 to which the driving current Id should be applied is controlled to emit light, so that the driving current Id can be applied to the sixth light emitting device ED6. When the driving current Id is applied to the sixth light emitting device ED6, the driving current Id can be applied to the seventh light emitting device ED7, the ninth light emitting device ED9, and the tenth light emitting device ED10 that are electrically connected to the sixth light emitting device ED6.

Because one stroke of the “HH” text in the optical area OA is displayed from the light emitting devices ED arranged in two rows or two columns, the thickness of the stroke in the optical area OA can be 2. Accordingly, when the same text as the text displayed in the normal area NA is displayed in the optical area OA, the thickness of the text stroke displayed in the optical area OA can be thicker than the thickness of the text stroke displayed in the normal area NA.

As a result, by controlling the driving current Id to flow to the light emitting device ED adjacent to the light emitting device ED on which the text should be displayed, the “HH” text can be displayed in the optical area OA without loss of stroke. Therefore, there can be an effect of displaying text without loss of text stroke in the optical area OA to which the 1:N circuit connection method is applied.

Also, in the optical area OA shown in FIG. 8, there is an effect that a text image can be expressed without loss of strokes, but when displaying the “HH” text in the optical area OA, a driving current Id is controlled to flow to a light emitting device ED adjacent to the light emitting device ED on which the “HH” text should be displayed, and the driving current Id is controlled to flow again to an adjacent light emitting device ED electrically connected to the corresponding light emitting device ED through an anode extension line AEL, a problem can occur in which each character of the “HH” text is displayed adjacent to each other without a distinction between the texts.

Therefore, in the optical area OA to which the 1:4 circuit connection method is applied, a switch transistor SWT can be disposed between adjacent light emitting devices ED to solve the problem of loss of text strokes and the problem of texts being displayed adjacent to each other.

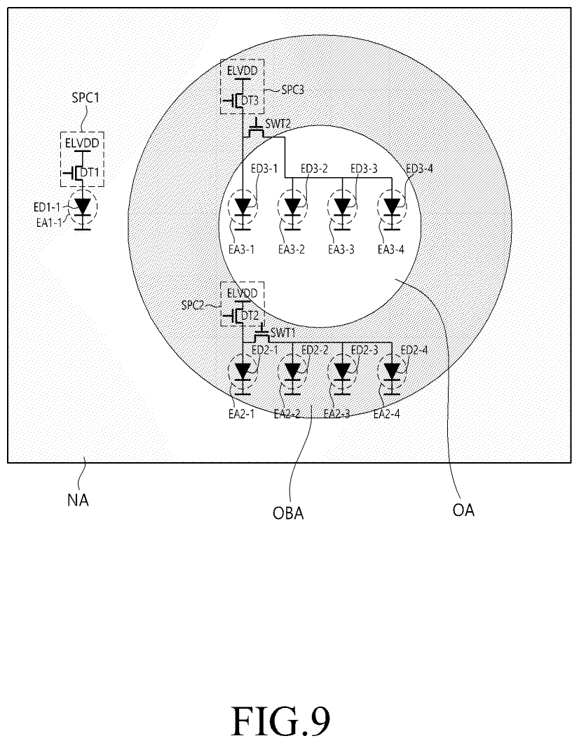

Next, FIG. 9 illustrates light emitting devices ED1-1, ED2-1, ED2-2, ED2-3, ED2-4, ED3-1, ED3-2, ED3-3 and ED3-4 arranged in a normal area NA, an optical bezel area OBA, and an optical area OA in a display panel 110 according to embodiments of the present disclosure, pixel circuits SPC1, SPC2 and SPC3 for driving the light emitting devices ED1-1, ED2-1, ED2-2, ED2-3, ED2-4, ED3-1, ED3-2 and ED3-3, ED3-4, and switch transistors SWT1 and SWT2 arranged in the optical bezel area OBA.

However, as in the description in FIG. 5, each of the pixel circuits SPC1, SPC2 and SPC3 can include transistors DT and ST, and storage capacitors Cst, as in FIG. 3. However, for convenience of explanation, each of the pixel circuits SPC1, SPC2 and SPC3 is simply expressed as a driving transistor DT1, DT2 and DT3.

Referring to FIG. 9, the configuration can be the same as FIG. 5 except that a first switch transistor SWT1 and a second switch transistor SWT2 are disposed in the optical bezel area OBA. Therefore, in FIG. 9, the description will be focused on the parts that are different from FIG. 5, and the description of the configurations that are identical to FIG. 5 will be omitted.

Referring to FIG. 9, in the configuration of the second pixel circuit SPC2 disposed in the optical bezel area OBA, and the 2-1 light emitting device ED2-1, the 2-2 light emitting device ED2-2, the 2-3 light emitting device ED2-3, and the 2-4 light emitting device ED2-4 connected thereto, a first switch transistor SWT1 can be disposed between the 2-1 light emitting device ED2-1 and the 2-2 light emitting device ED2-2.

In addition, the 2-1 light emitting device ED2-1, the 2-2 light emitting device ED2-2, the 2-3 light emitting device ED2-3, and the 2-4 light emitting device ED2-4 arranged in the optical bezel area OBA can be electrically connected to each other, and can output light of the same wavelength band. That is, a 1:4 circuit connection method can be applied to the optical bezel area OBA.

When a driving current Id is applied to a light emitting device ED through a second pixel circuit SPC2, the driving current Id can be applied to the 2-1 light emitting device ED2-1, but depending on the state of the first switch transistor SWT1, the driving current Id cannot be applied to the 2-2 light emitting device ED2-2, the 2-3 light emitting device ED2-3, and the 2-4 light emitting device ED2-4.

In addition, in the configuration of the third pixel circuit SPC3 disposed in the optical area OA, and the 3-1 light emitting device ED3-1, the 3-2 light emitting device ED3-2, the 3-3 light emitting device ED3-3, and the 3-4 light emitting device ED3-4 connected thereto, a second switch transistor SWT2 can be disposed between the 3-1 light emitting device ED3-1 and the 3-2 light emitting device ED3-2.

Further, the 3-1 light emitting device ED3-1, the 3-2 light emitting device ED3-2, the 3-3 light emitting device ED3-3, and the 3-4 light emitting device ED3-4 arranged in the optical area OA can be electrically connected to each other, and can output light of the same wavelength band. That is, a 1:4 circuit connection method can be applied to the optical area OA.

When the driving current Id is applied to the light emitting device ED through the third pixel circuit SPC3, the driving current Id can be applied to the 3-1 light emitting device ED3-1, but depending on the state of the second switch transistor SWT2, the driving current Id cannot be applied to the 3-2 light emitting device ED3-2, the 3-3 light emitting device ED3-3, and the 3-4 light emitting device ED3-4.

In this instance, the first switch transistor SWT1 and the second switch transistor SWT2 can be disposed in the optical bezel area OBA, or can be disposed in the optical area OA. However, because it is preferable to be arranged in the optical bezel area OBA in order to secure the aperture ratio of the optical area OA, it is illustrated that the first switch transistor SWT1 and the second switch transistor SWT2 are disposed in the optical bezel area OBA. Therefore, the first switch transistor SWT1 and the second switch transistor SWT2 do not overlap with the transmission area TA of the optical area OA. However, the embodiments of the present disclosure are not limited thereto.

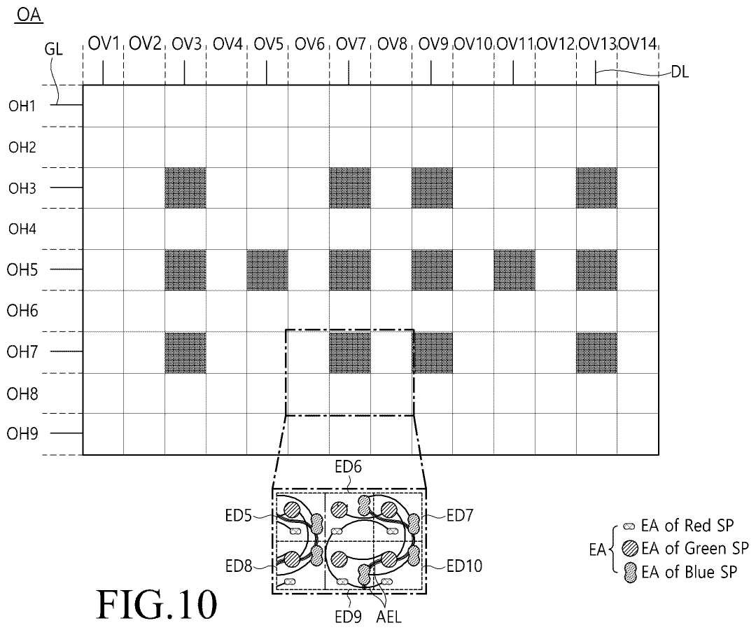

Next, FIG. 10 is an overview illustrating a matrix of light emitting devices ED supplied with a driving current when the switch transistor SWT structure is applied as in FIG. 9 and the text “HH” is displayed in the optical area OA. Referring to FIG. 10, the optical area OA can include a matrix of light emitting devices ED arranged in 9 rows and 14 columns. The matrix of light emitting devices ED shown in FIG. 10 can represent a part of the optical area OA. The optical area OA shown in FIG. 10 can be applied with a 1:4 circuit connection method, similar to the optical area OA shown in FIG. 9.

Referring to FIG. 10, the matrix of the optical area OA can include a fifth light emitting device ED5 arranged in the sixth column OV6 and seventh row OH7, a sixth light emitting device ED6 arranged in the seventh column OV7 and seventh row OH7, a seventh light emitting device ED7 arranged in the eighth column OV8 and seventh row OH7, an eighth light emitting device ED8 arranged in the sixth column OV6 and eighth row OH8, a ninth light emitting device ED9 arranged in the seventh column OV7 and eighth row OH8, and a tenth light emitting device ED10 arranged in the eighth column OV8 and eighth row OH8 of the optical area OA.

In this instance, a data line DL is not arranged in the sixth column OV6 and the eighth column OV8 of the optical area OA, and a data line is arranged in the seventh column OV7. In addition, a gate line GL can be arranged in the seventh row OH7 of the optical area OA, and no gate line can be arranged in the eighth row OH8. In this instance, the sixth light emitting device ED6, the seventh light emitting device ED7, the ninth light emitting device ED9, and the tenth light emitting device ED10 can be electrically connected to each other so as to output light of the same wavelength band.

In addition, a second switch transistor SWT2 can be disposed between the sixth light emitting device ED6, the seventh light emitting device ED7, the ninth light emitting device ED9, and the tenth light emitting device ED10. In order to express a text image without loss of strokes, like the optical area OA shown in FIG. 8, when displaying the text “HH” in the optical area OA, the driving current Id can be controlled to flow to the light emitting device ED adjacent to the light emitting device ED on which the text “HH” should be displayed, and the driving current Id can be controlled to flow again to the adjacent light emitting device ED electrically connected to the corresponding light emitting device ED through the anode extension line AEL.

Therefore, when displaying the “HH” text in the optical area OA, the data line DL is not connected to the fifth light emitting device ED5 to which the driving current Id should be applied, so the driving current Id is not applied, and the sixth light emitting device ED6 adjacent to the fifth light emitting device ED5 to which the driving current Id should be applied is controlled to emit light, so that the driving current Id can be applied to the sixth light emitting device ED6.

In this instance, the driving current Id should also be applied to the seventh light emitting device ED7, the ninth light emitting device ED9, and the tenth light emitting device ED10 connected to the sixth light emitting device ED6, but in order to solve the problem of displaying the characters of the “HH” text adjacent to each other, the second switch transistor SWT2 disposed in the optical area OA can be activated. The switch transistors SWT1 and SWT2 disposed on the display panel 110 can all be P-type transistors.

That is, the second switch transistor SWT2 disposed on the optical area OA can apply an activation signal to a gate electrode when displaying a text image on the optical area OA. The second switch transistor SWT2 can be a P-type transistor that blocks a source-drain current when an activation signal is applied to the gate electrode. Therefore, if the second switch transistor SWT2 connected between the sixth light emitting device ED6 and the seventh light emitting device ED7 is activated, the driving current Id applied from the third pixel circuit SPC3 to the seventh light emitting device ED7, the ninth light emitting device ED9, and the tenth light emitting device ED10 can be blocked.

That is, even if the sixth light emitting device ED6 is connected to the seventh light emitting device ED7, the ninth light emitting device ED9, and the tenth light emitting device ED10 through the anode extension line AEL, the second switch transistor SWT2 connected between the sixth light emitting device ED6 and the seventh light emitting device ED7 can be activated, so that there can be blocked the driving current Id flowing to the seventh light emitting device ED7, the ninth light emitting device ED9, and the tenth light emitting device ED10.

The method of controlling the driving current Id to flow only to one of the four light emitting devices ED in the optical area OA of the 1:4 circuit connection method through a switch transistor SWT can be applied to the entire optical area OA shown in FIG. 10.

Therefore, if the “HH” text shown in FIG. 6 is displayed in the optical area OA of FIG. 10 of the 1:4 circuit connection method where the switch transistor SWT is disposed, the driving current Id can be applied only to the third column OV3 and third row OH3, the third column OV3 and fifth row OH5, the third column OV3 and seventh row OH7, the fifth column OV5 and fifth row OH5, the seventh column OV7 and third row OH3, the seventh column OV7 and fifth row OH5, the seventh column OV7 and seventh row OH7, the ninth column OV9 and third row OH3, the ninth column OV9 and fifth row OH5, the ninth column OV9 and seventh row OH7, the eleventh column OV11 and fifth row OH5, the thirteenth column OV13 and third row OH3, the thirteenth column OV13 and fifth row OH5, and the thirteenth column OV13 and seventh row OH7.

Therefore, when displaying the text “HH” in the optical area OA, the strokes of the text can be displayed discontinuously by the second switch transistor SWT2. In this way, when displaying the text “HH” in the optical area OA, the driving current Id is applied to the light emitting device ED to which the driving current Id should be applied, as well as to the adjacent light emitting device ED, and a switch transistor SWT is disposed between the light emitting devices ED electrically connected to each other through an anode extension line AEL arranged in the optical area OA, so that, when displaying the text in the optical area OA of the 1:4 circuit connection method, the driving current Id can be controlled through the switch transistor SWT to flow only to one of the four light emitting devices ED, thereby displaying the text in the optical area OA without loss of strokes, and resolving the problem that the displayed texts are adjacent and not distinguishable. Therefore, it is possible to improve the readability of the text image displayed in the optical area OA.

In addition, the structure including the switch transistor SWT of the optical area OA shown in FIGS. 9 and 10 can be equally applied to the optical bezel area OBA. In addition, referring to FIGS. 9 and 10, the 3-1 light emitting device ED3-1 of FIG. 9 can correspond to the sixth light emitting device ED6 of FIG. 10. Also, the 3-2 light emitting device ED3-2 of FIG. 9 can correspond to the seventh light emitting device ED7 of FIG. 10, the 3-3 light emitting device ED3-3 of FIG. 9 can correspond to the ninth light emitting device ED9 of FIG. 10, and the 3-4 light emitting device ED3-4 of FIG. 9 can correspond to the tenth light emitting device ED10 of FIG. 10.

However, the arrangement order of the light emitting devices ED shown in FIG. 10 is not limited thereto. Specifically, because the 3-1 light emitting device ED3-1 shown in FIG. 9 is connected in series with the third pixel circuit SPC3, the sixth light emitting device ED6 of FIG. 10 corresponding to the 3-1 light emitting device ED3-1 can be connected in series with the third pixel circuit SPC3, but the light emitting device connected in series with the third pixel circuit SPC3 can be the seventh light emitting device ED7, the ninth light emitting device ED9, and the tenth light emitting device ED10 of FIG. 10.

In addition, it is illustrated that the sixth light emitting device ED6 is disposed in the seventh column OV7 and seventh row OH7, the seventh light emitting device ED7 is disposed in the eighth column OV8 and seventh row OH7, the ninth light emitting device ED9 is disposed in the seventh column OV7 and eighth row OH8, and the tenth light emitting device ED10 is disposed in the eighth column OV8 and eighth row OH8, which are electrically connected to each other through the anode extension line AEL, but the matrix arrangement order of the sixth light emitting device ED6, the seventh light emitting device ED7, the ninth light emitting device ED9, and the tenth light emitting device ED10 electrically connected to each other through the anode extension line AEL is not limited thereto, and the upper, lower, left, and right positions of the light emitting devices relative to the front of the display panel 110 can be modified in various ways.

The embodiment of the present disclosure is not limited thereto. In particular, the number of light emitting devices ED and switch transistors SWT connected to one pixel circuit SPC can be configured in various ways. For example, M (M is a natural number greater than 3) light emitting devices ED can be arranged in the optical area OA. The pixel circuit SPC can supply a driving current Id to N (N is a natural number greater than 1 and less than M) light emitting devices ED arranged in the optical area. In addition, at least one switch transistor SWT can be disposed, and the switch transistor SWT can selectively block the driving current Id applied to some of the N light emitting devices ED.

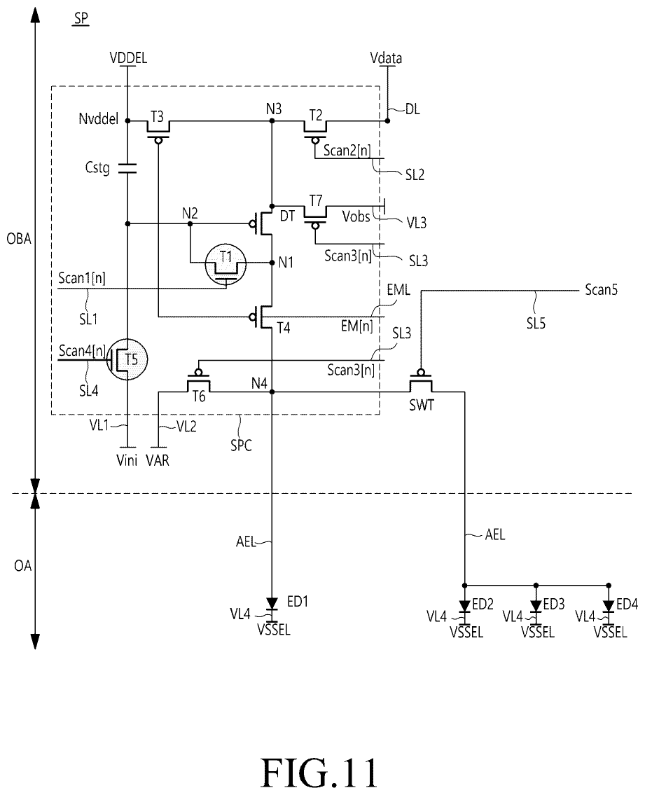

Next, FIGS. 11-15 are overviews illustrating various embodiments of sub-pixels SP according to embodiments of the present disclosure. Referring to FIG. 11, the pixel circuit SPC can be disposed differently from the pixel circuit SPC shown in FIG. 3.

In addition, the pixel circuit SPC can include a plurality of transistors DT and T1 to T7, and a storage capacitor Cstg. The transistors DT and T1 to T7 can all be configured as P-type transistors or can be configured as N-type transistors. The transistors DT and T1 to T7 can be implemented as PMOS type LTPS (Low Temperature Poly Silicon) transistors having good response characteristics. In addition, a transistor connected to a gate electrode of a driving transistor DT can be formed as an NMOS type oxide transistor having a small leakage current.

In addition, the driving transistor DT can supply a driving current Id to the light emitting devices ED1, ED2, ED3 and ED4, and can be electrically connected between a first node N1 and a third node N3. The first node N1 can be a source node of the driving transistor DT, and the third node N3 can be the drain node of the driving transistor DT. Alternatively, the first node N1 can be the drain node of the driving transistor DT, and the third node N3 can be the source node of the driving transistor DT. The gate node of the driving transistor DT can be electrically connected to a second node N2. The gate node of the driving transistor DT can be the second node N2. Referring to FIG. 11, the driving transistor DT can be a P-type transistor, but is not limited thereto.

A first transistor T1 can be electrically connected between the second node N2 and the third node N3. The gate node of the first transistor T1 can be electrically connected to a first scan line SL1 that receives a first scan signal Scan1[n]. Referring to FIG. 11, the first transistor T1 can be an N-type transistor, but is not limited thereto. The first transistor T1 can be an oxide transistor, but is not limited thereto.

Also, a second transistor T2 can be electrically connected between the first node N1 and a data line DL. A gate node of the second transistor T2 can be electrically connected to a second scan line SL2 that receives a second scan signal Scan2[n]. Referring to FIG. 11, the second transistor T2 can be a P-type transistor, but is not limited thereto. A third transistor T3 can be electrically connected between a high voltage node Nvddel supplied with a high voltage VDDEL and the first node N1. The gate node of the third transistor T3 can be electrically connected to an emission control line EML supplied with an emission control signal EM[n]. Referring to FIG. 11, the third transistor T3 can be a P-type transistor, but is not limited thereto.

A fourth transistor T4 can be electrically connected between the third node N3 and a fourth node N4. The gate node of the fourth transistor T4 can be electrically connected to the emission control line EML supplied with the emission control signal EM[n]. Referring to FIG. 11, the fourth transistor T4 can be a P-type transistor, but is not limited thereto. A fifth transistor T5 can be electrically connected between a line VL1 supplied with an initialization voltage Vini and the second node N2. The gate node of the fifth transistor T5 can be electrically connected to a fourth scan line SL4 supplied with the fourth scan signal Scan4[n]. Referring to FIG. 11, the fifth transistor T5 can be an N-type transistor, but is not limited thereto. The fifth transistor T5 can be an oxide transistor, but is not limited thereto.

Also, a sixth transistor T6 can be electrically connected between a line VL2 supplied with an anode electrode reset voltage VAR for resetting the anode electrode and the fourth node N4. The gate node of the sixth transistor T6 can be electrically connected to a third scan line SL3 that receives a third scan signal Scan3[n+1]. Referring to FIG. 11, the sixth transistor T6 can be a P-type transistor, but is not limited thereto. A seventh transistor T7 can be electrically connected between a line VL3 supplied with an on-bias stress voltage Vobs and the first node N1. The gate node of the seventh transistor T7 can be electrically connected to a third scan line SL3 supplied with a third scan signal Scan3[n]. Referring to FIG. 11, the seventh transistor T7 can be a P-type transistor, but is not limited thereto.

In addition, the storage capacitor Cstg can be electrically connected between the second node N2 and a high voltage node Nvddel supplied with a high voltage (VDDEL). The storage capacitor Cstg can be charged with a charge amount corresponding to the voltage difference between the two terminals, and serve to maintain the voltage difference between the two terminals for a predetermined frame time. That is, the storage capacitor Cstg can be connected between the first node N1 and the high voltage node Nvddel, and can store the data voltage Vdata compensated for by a threshold voltage Vth of the driving transistor DT.

Further, the first light emitting device ED1 can be electrically connected between the fourth node N4 of the pixel circuit SPC and a line VL4 supplied with a low voltage VSSEL. A switch transistor SWT can be disposed between the fourth node N4 and a second light emitting device ED2, a third light emitting device ED3, and a fourth light emitting device ED4. That is, the switch transistor SWT can be disposed between a first light emitting device ED1, the second light emitting device ED2, the third light emitting device ED3, and the fourth light emitting device ED4. The gate node of the switch transistor SWT can be electrically connected to a fifth scan line SL5 supplied with a fifth scan signal Scan5. Referring to FIG. 11, the switch transistor SWT can be a P-type transistor, but is not limited thereto.

If the switch transistor SWT receives the fifth scan signal Scan5 from the fifth scan line SL5, the driving current Id can be blocked from flowing from the pixel circuit SPC to the second light emitting device ED2, the third light emitting device ED3, and the fourth light emitting device ED4. In this instance, the fifth scan signal Scan5 can be a switch signal. The second light emitting device ED2, the third light emitting device ED3, and the fourth light emitting device ED4 can be electrically connected between the switch transistor SWT and the line VL4 supplied with the low voltage VSSEL. The second light emitting device ED2, the third light emitting device ED3, and the fourth light emitting device ED4 can be electrically connected to each other.

In addition, the light emitting devices ED1, ED2, ED3 and ED4 can have a parasitic capacitor formed between the pixel electrode PE and the common electrode CE. In addition, while the light emitting devices ED1, ED2, ED3 and ED4 emit light, the parasitic capacitor can be charged so that the pixel electrodes of the light emitting devices ED1, ED2, ED3 and ED4 can have a specific voltage. Accordingly, the anode electrode reset voltage VAR can be supplied to the pixel electrode PE of the light emitting devices ED1, ED2, ED3 and ED4 through the sixth transistor T6, thereby initializing the amount of charge accumulated in the light emitting devices ED1, ED2, ED3 and ED4.

Further, the pixel circuit SPC and the switch transistor SWT can be disposed in the optical bezel area OBA. The first light emitting device ED1, the second light emitting device ED2, the third light emitting device ED3, and the fourth light emitting device ED4 can be disposed in the optical area OA. The pixel circuit SPC and the switch transistor SWT can be connected to the first light emitting device ED1, the second light emitting device ED2, the third light emitting device ED3, and the fourth light emitting device ED4 through an anode extension line AEL.

Also, the first light emitting device ED1, the second light emitting device ED2, the third light emitting device ED3, and the fourth light emitting device can be light emitting devices ED that output the same type of light. Meanwhile, the switch transistor SWT can be disposed between the first light emitting device ED1 and the second light emitting device ED2 and the third light emitting device ED3 and the fourth light emitting device ED4.

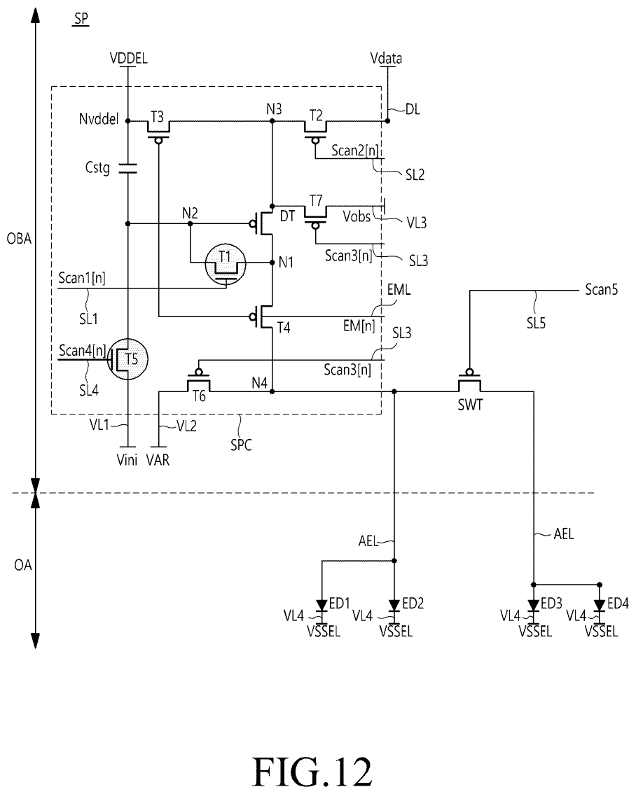

Referring to FIG. 12, the remaining configurations except for the positions where the light emitting devices ED1, ED2, ED3 and ED4 and the switch transistor SWT are arranged can be the same as FIG. 11. Therefore, the description of the configurations that are identical to FIG. 11 will be omitted.

As shown in FIG. 12, the first light emitting device ED1 and the second light emitting device ED2 can be electrically connected between the fourth node N4 of the pixel circuit SPC and the line VL4 supplied with the low voltage VSSEL. The first light emitting device ED1 and the second light emitting device ED2 can be electrically connected. The first light emitting device ED1 and the second light emitting device ED2 can be arranged in the optical area OA and can be connected to the fourth node N4 of the pixel circuit SPC arranged in the optical bezel area OBA through the anode extension line AEL.

In addition, the switch transistor SWT can be disposed between the fourth node N4 and the third light emitting device ED3 and the fourth light emitting device ED4. That is, the switch transistor SWT can be disposed between the first light emitting device ED1 and the second light emitting device ED2 and the third light emitting device ED3 and the fourth light emitting device ED4. The switch transistor SWT can be disposed in the optical bezel area OBA.

If the switch transistor SWT receives the fifth scan signal Scan5 from the fifth scan line SL5, the driving current Id can be blocked from flowing from the pixel circuit SPC to the third light emitting device ED3 and the fourth light emitting device ED4. In this instance, the fifth scan signal Scan5 can be a switch signal. The third light emitting device ED3 and the fourth light emitting device ED4 can be electrically connected between the switch transistor SWT and the line VL4 supplied with the low voltage VSSEL. The third light emitting device ED3 and the fourth light emitting device ED4 can be electrically connected to each other. The third light emitting device ED3 and the fourth light emitting device ED4 can be disposed in the optical area OA. Meanwhile, the switch transistor SWT can be disposed between the first light emitting device ED1, the second light emitting device ED2, the third light emitting device ED3, and the fourth light emitting device ED4.

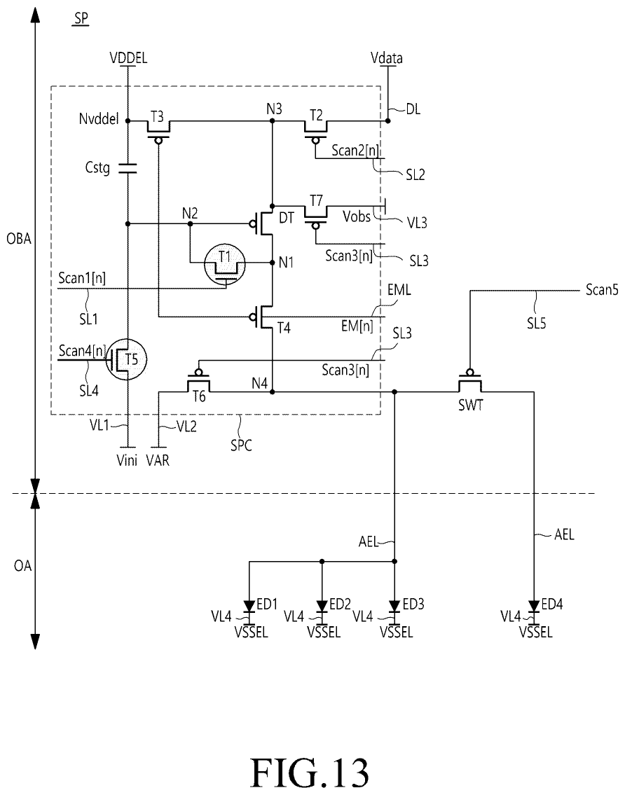

Referring to FIG. 13, the remaining configurations except for the positions where the light emitting devices ED1, ED2, ED3 and ED4 and the switch transistor SWT are arranged can be the same as FIG. 11. Therefore, the description of the configurations that are identical to FIG. 11 will be omitted.

As shown in FIG. 13, the first light emitting device ED1, the second light emitting device ED2, and the third light emitting device ED3 can be electrically connected between the fourth node N4 of the pixel circuit SPC and the line VL4 to which the low voltage VSSEL is supplied. The first light emitting device ED1, the second light emitting device ED2, and the third light emitting device ED3 can be electrically connected. The first light emitting device ED1, the second light emitting device ED2, and the third light emitting device ED3 can be disposed in the optical area OA, and can be connected to the fourth node N4 of the pixel circuit SPC disposed in the optical bezel area OBA through the anode extension line AEL.

In addition, the switch transistor SWT can be disposed between the fourth node N4 and the fourth light emitting device ED4. That is, the switch transistor SWT can be disposed between the first light emitting device ED1, the second light emitting device ED2, the third light emitting device ED3, and the fourth light emitting device ED4. The switch transistor SWT can be disposed in the optical bezel area OBA.

If the switch transistor SWT receives the fifth scan signal Scan5 from the fifth scan line SL5, the driving current Id can be blocked from flowing from the pixel circuit SPC to the fourth light emitting device ED4. In this instance, the fifth scan signal Scan5 can be a switch signal.

Also, the fourth light emitting device ED4 can be electrically connected between the switch transistor SWT and the line VL4 to which the low voltage VSSEL is supplied. The fourth light emitting device ED4 can be disposed in the optical area OA. Meanwhile, a plurality of switch transistors SWT can be disposed.

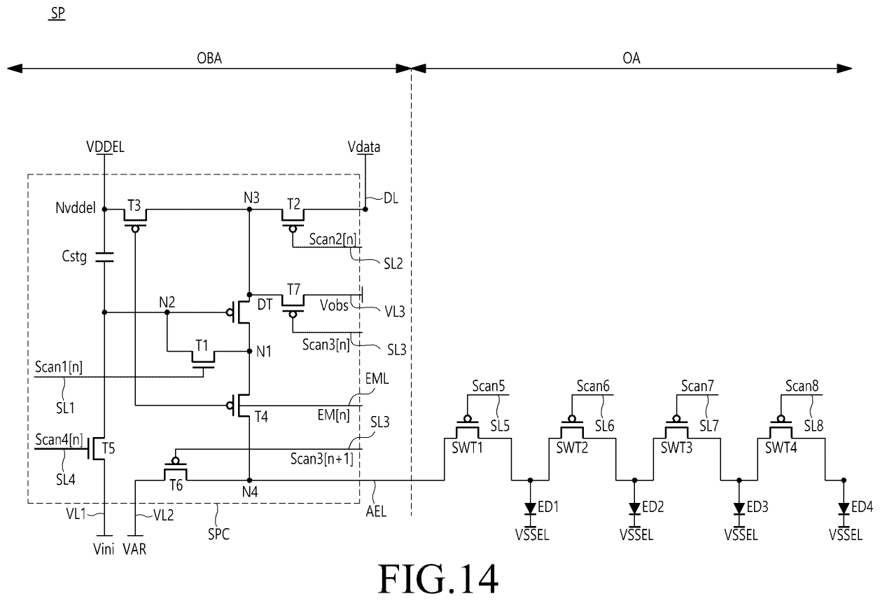

Referring to FIG. 14, a plurality of switch transistors SWT can be disposed. Also, the remaining configurations except for the light emitting devices ED1, ED2, ED3 and ED4 and the switch transistors SWT1, SWT2, SWT3 and SWT4 can be the same as FIG. 11. Therefore, the description of the configurations that are identical to FIG. 11 will be omitted.

Referring to FIG. 14, a first switch transistor SWT1 can be disposed between the first light emitting device ED1 and the fourth node N4. The first switch transistor SWT1 can be disposed in the optical area OA. In addition, the first switch transistor SWT1 can be connected to the fourth node N4 of the pixel circuit SPC disposed in the optical area OA through the anode extension line AEL. If the first switch transistor SWT1 receives the fifth scan signal Scan5 from the fifth scan line SL5, the first switch transistor SWT1 can block the driving current Id from flowing from the pixel circuit SPC to the first light emitting device ED1. In this instance, the fifth scan signal Scan5 can be a switch signal.

Referring to FIG. 14, a second switch transistor SWT2 can be disposed between the first light emitting device ED1 and the second light emitting device ED2. The second switch transistor SWT2 can be disposed in the optical area OA. The second switch transistor SWT2 can be connected between the first light emitting device ED1 and the second light emitting device ED2 through the anode extension line AEL. If the driving current Id is applied to the first light emitting device ED1, the second switch transistor SWT2 can block the driving current Id from flowing to the second light emitting device ED2 when a sixth scan signal Scan6 is applied from a sixth scan line SL6. In this instance, the sixth scan signal Scan6 can be a switch signal.

Referring to FIG. 14, a third switch transistor SWT3 can be disposed between the second light emitting device ED2 and the third light emitting device ED3. The third switch transistor SWT3 can be disposed in the optical area OA. Further, the third switch transistor SWT3 can be connected between the second light emitting device ED2 and the third light emitting device ED3 through the anode extension line AEL. If the driving current Id is applied to the second light emitting device ED2, the third switch transistor SWT3 can block the driving current Id from flowing to the third light emitting device ED3 when a seventh scan signal Scan7 is applied from a seventh scan line SL7. In this instance, the seventh scan signal Scan7 can be a switch signal.

As shown in FIG. 14, a fourth switch transistor SWT4 can be disposed between the third light emitting device ED3 and the fourth light emitting device ED4. The fourth switch transistor SWT4 can be disposed in the optical area OA. In particular, the fourth switch transistor SWT4 can be connected between the third light emitting device ED3 and the fourth light emitting device ED4 via the anode extension line AEL. If the driving current Id is applied to the third light emitting device ED3, the fourth switch transistor SWT4 can block the driving current Id from flowing to the fourth light emitting device ED4 when an eighth scan signal Scan8 is applied from an eighth scan line SL8. In this instance, the eighth scan signal Scan8 can be a switch signal.

Also, the first switch transistor SWT1, the second switch transistor SWT2, the third switch transistor SWT3, and the fourth switch transistor SWT4 are illustrated as being disposed in the optical area OA, but the embodiment of the present disclosure is not limited thereto. For example, some of the first switch transistor SWT1, the second switch transistor SWT2, the third switch transistor SWT3, and the fourth switch transistor SWT4 can be disposed in the optical bezel area OBA, and the remaining some can be disposed in the optical area OA. Alternatively, all of the first switch transistor SWT1, the second switch transistor SWT2, the third switch transistor SWT3, and the fourth switch transistor SWT4 can be disposed in the optical bezel area OBA.

In addition, the first switch transistor SWT1, the second switch transistor SWT2, the third switch transistor SWT3, and the fourth switch transistor SWT4 of the embodiment of the present disclosure are not limited thereto. Specifically, some of the first switch transistor SWT1, the second switch transistor SWT2, the third switch transistor SWT3, and the fourth switch transistor SWT4 cannot be disposed. That is, the switch transistor SWT can be disposed at least one of the positions between the fourth node N4 of the pixel circuit SPC and the first light emitting device ED1, between the first light emitting device ED1 and the second light emitting device ED2, between the second light emitting device ED2 and the third light emitting device ED3, and between the third light emitting device ED3 and the fourth light emitting device ED4. The number and position of the switch transistors SWT can be adjusted according to the number and position of the light emitting devices ED to which the driving current Id is to be applied.

As shown in FIG. 14, the first switch transistor SWT1, the first light emitting device ED1, the second switch transistor SWT2, the second light emitting device ED2, the third switch transistor SWT3, the third light emitting device ED3, the fourth switch transistor SWT4 and the fourth light emitting device ED4 can be connected in series, but can be connected in parallel as a unit of the switch transistor SWT and the light emitting device ED.

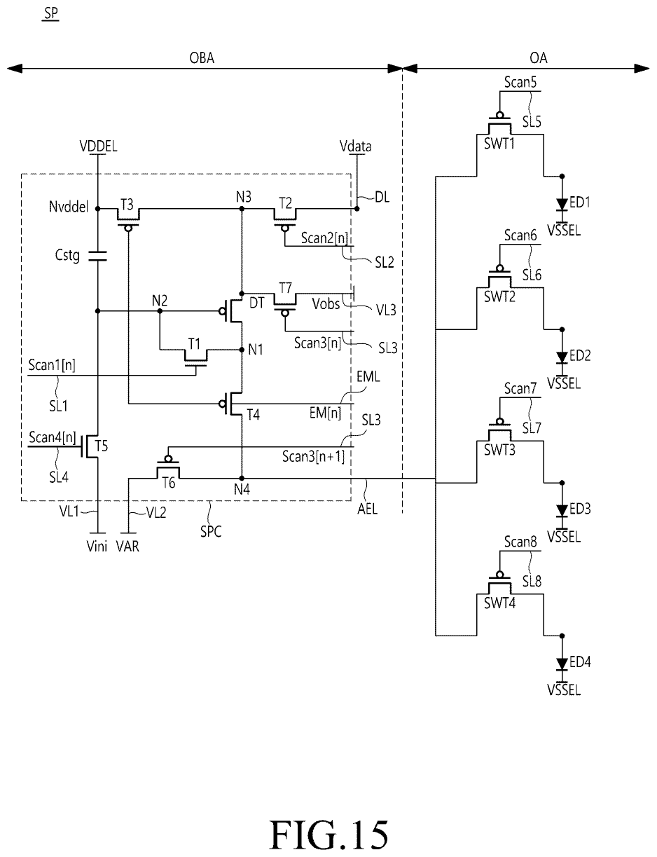

Referring to FIG. 15, a plurality of switch transistors SWT can be disposed. In particular, the source electrode or the drain electrode of the first switch transistor SWT1, the second switch transistor SWT2, the third switch transistor SWT3, and the fourth switch transistor SWT4 can all be directly connected to the fourth node N4.

As shown, the drain electrode or the source electrode of the first switch transistor SWT1 can be connected to the first light emitting device ED1. The drain electrode or the source electrode of the second switch transistor SWT2 can be connected to the second light emitting device ED2. The drain electrode or the source electrode of the third switch transistor SWT3 can be connected to the third light emitting device ED3. The drain electrode or the source electrode of the fourth switch transistor SWT4 can be connected to the fourth light emitting device.

Therefore, the light emitting devices ED1, ED2, ED3 and ED4 can be controlled in a parallel structure through the switch transistors SWT1, SWT2, SWT3 and SWT4 connected to the pixel circuit SPC. The first switch transistor SWT1, the second switch transistor SWT2, the third switch transistor SWT3, and the fourth switch transistor SWT4 of the embodiment of the present disclosure are not limited thereto. Specifically, some of the first switch transistor SWT1, the second switch transistor SWT2, the third switch transistor SWT3, and the fourth switch transistor SWT4 cannot be disposed. The number and the arrangement positions of the switch transistors SWT can be adjusted according to the number and positions of the light emitting devices ED to which the driving current Id is to be applied.

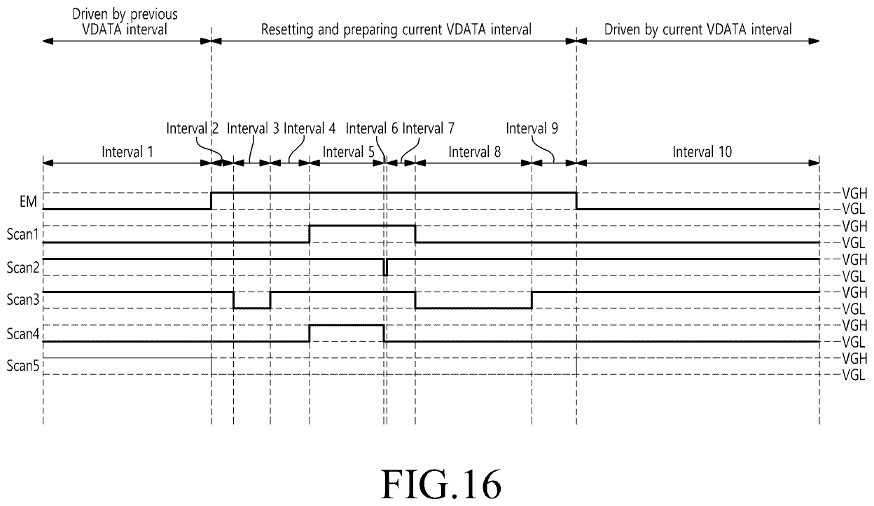

Next, FIG. 16 is a timing diagram for a signal supplied to the sub-pixel SP shown in FIG. 11. Referring to FIG. 16, the signals (e.g., EM, Scan1, Scan2, Scan3, Scan4, Scan5) shown in FIG. 11 can be supplied to the sub-pixels SP according to the timing of a first interval Interval 1, a second interval Interval 2, a third interval Interval 3, a fourth interval Interval 4, a fifth interval Interval 5, a sixth interval Interval 6, a seventh interval Interval 7, an eighth interval Interval 8, a ninth interval Interval 9, and a tenth interval Interval 10.

In addition, the timing for lighting the light emitting device ED included in each sub-pixel SP can include three intervals. First, a previous data voltage driving interval (which is represented as ‘Driven by previous VDATA interval’) can be included in which a driving current Id is supplied to a light emitting device ED by a data voltage VDATA corresponding to a previous frame displayed on a display panel 110. The previous data voltage driving interval can include a first interval Interval 1.

Second, a resetting and preparing current data voltage preparation interval (which is represented as ‘Resetting and preparing current VDATA interval’) can be included in which a voltage applied to a sub-pixel SP by a data voltage VDATA corresponding to a previous frame is initialized and prepared to apply a data voltage VDATA corresponding to a current frame. The resetting and preparing current VDATA interval can include the second interval Interval 2, the third interval Interval 3, the fourth interval Interval 4, the fifth interval Interval 5, the sixth interval Interval 6, the seventh interval Interval 7, the eighth interval Interval 8, and the ninth interval Interval 9.

Third, a current data voltage driving interval (which is represented as ‘Driven by current VDATA interval’) can be included in which a driving current Id is supplied to a light emitting device ED by a data voltage VDATA corresponding to a current frame. The driven by current VDATA interval can include the tenth interval Interval 10.

In addition, the first transistor T1 having a gate node supplied with the first scan signal Scan1 can be an N-type transistor. In addition, the fifth transistor T5 having a gate node supplied with the fourth scan signal Scan4 can be an N-type transistor. Therefore, the first transistor T1 and the fifth transistor T5 can be activated when a high voltage VGH is applied to the gate node. In this instance, the activating a transistor can mean that current flows through the source-drain electrodes of the transistor.

Also, the second transistor T2 having a gate node supplied with the second scan signal Scan2, the seventh transistor T7 having a gate node supplied with the third scan signal Scan3, and the switch transistor SWT having a gate node supplied with the fifth scan signal Scan5 can be P-type transistors. Therefore, the second transistor T2, the seventh transistor T7, and the fifth transistor T5 can be activated when the low voltage VHL is applied.

In the first interval Interval 1, a state can be maintained in which the driving current Id flows to the light emitting device ED due to the data voltage VDATA corresponding to the previous frame. In this instance, because the fifth scan signal Scan5 has a low voltage VGL, the driving current Id can be applied to the first light emitting device ED1, but the driving current Id cannot be applied to the second light emitting device ED2, the third light emitting device ED3, and the fourth light emitting device ED4.

In the second interval Interval 2, the emission control signal EM can be switched to a high voltage VGH. Therefore, the fourth transistor T4 that receives the emission control signal EM at the gate node through the emission control line EML can be deactivated. In this instance, the deactivating of a transistor can mean that the current does not flow through the source-drain electrodes of the transistor.

If the fourth transistor T4 is deactivated in the second interval Interval 2, the driving current Id cannot be applied to the light emitting device ED. This can be a preparatory step for initializing the voltage applied to the first light emitting device ED1, the second light emitting device ED2, the third light emitting device ED3, and the fourth light emitting device ED4.

In the third interval Interval 3, the third scan signal Scan3 can be switched to a low voltage (VGL). Therefore, the sixth transistor T6 that receives the third scan signal Scan3 at a gate node through the third scan line SL3 can be activated. If the sixth transistor T6 is activated, the anode electrode reset voltage VAR can be supplied to all light emitting devices ED1, ED2, ED3 and ED4 connected to the pixel circuit SPC, so that the voltage corresponding to the previous frame applied to all light emitting devices ED1, ED2, ED3 and ED4 can be initialized.

In addition, in the third interval Interval 3, the seventh transistor T7, which is another transistor that receives third scan signal Scan3 from the third scan line SL3 at a gate node, can be activated. If the seventh transistor T7 is activated, the on-bias stress voltage Vobs can be applied to the source node of the driving transistor DT, so that the voltage corresponding to the previous frame can be initialized.

In the fourth interval Interval 4, the third scan signal Scan3 can be switched to a high voltage VGH. In the fourth interval Interval 4, after the voltage initialization of the light emitting devices ED1, ED2, ED3 and ED4 and the driving transistor DT is completed, the sixth transistor T6 and the seventh transistor T7 can be deactivated.

In the fifth interval Interval 5, the first scan signal Scan1 and the fourth scan signal Scan4 can be switched to a high voltage VGH. Accordingly, the first transistor T1 that receives the first scan signal Scan1 at a gate node through the first scan line SL1 can be activated. In addition, the fifth transistor T5 that receives the fourth scan signal Scan4 at a gate node through the fourth scan line SL4 can be activated. In the fifth interval Interval 5, if the first transistor T1 and the fifth transistor T5 are activated, the initialization voltage Vini can be applied to the gate node and drain node of the driving transistor DT, so that the voltage charged by the signal corresponding to the previous frame can be initialized.

In the sixth interval Interval 6, the second scan signal Scan2 and the fourth scan signal Scan4 can be switched to a low voltage VGL. Accordingly, the second transistor T2 that receives the second scan signal Scan2 at a gate node through the second scan line SL2 can be activated. Then, if the second transistor T2 is activated in the sixth interval Interval 6, after the voltage charged in the gate node and drain node of the driving transistor DT is initialized, and then the data voltage VDATA corresponding to the current frame can be applied to the gate node of the driving transistor DT.

In the seventh interval Interval 7, the second scan signal Scan2 can be switched to a high voltage VGH. Accordingly, the second transistor T2 that receives the second scan signal Scan2 at the gate node through the second scan line SL2 can be deactivated. Accordingly, the supply of the data voltage VDATA corresponding to the current frame to the driving transistor DT can be stopped.

In the eighth interval Interval 8, the first scan signal Scan1 can be switched to a low voltage VGL. Accordingly, the first transistor T1 that receives the first scan signal Scan1 at the gate node through the first scan line SL1 can be deactivated. If the first transistor T1 is deactivated, the electrical connection between the gate node and the source node of the driving transistor DT can be disconnected. Accordingly, the gate node of the driving transistor DT can be in a state where the voltage charged by the data voltage VDATA is maintained.

In addition, in the eighth interval Interval 8, the third scan signal Scan3 can be switched to a low voltage VGL. Accordingly, the sixth transistor T6 that receives the third scan signal Scan3 at a gate node through the third scan line SL3 can be activated. If the sixth transistor T6 is activated, the anode electrode reset voltage VAR can be applied to all light emitting devices ED1, ED2, ED3 and ED4 to be initialized. In addition, the seventh transistor T7, which is another transistor that receives the third scan signal Scan3 at a gate node through the third scan line SL3, can be activated to apply an on-bias stress voltage Vobs to the source node of the driving transistor DT, thereby initializing the voltage applied by the data voltage VDATA corresponding to the current frame.

In the ninth interval Interval 9, the third scan signal Scan3 can be switched to a high voltage VGH. Therefore, the sixth transistor T6 and the seventh transistor T7, which receive the third scan signal Scan3 at a gate node through the third scan line SL3, can be deactivated. In the ninth interval Interval 9, the sixth transistor T6 and the seventh transistor T7 can be deactivated, thereby completing the initialization of the source node voltage of the driving transistor DT.

In the tenth interval Interval 10, the emission control signal EM can be switched to a low voltage VGL. Therefore, the third transistor T3 and the fourth transistor T4, which receive the emission control signal EM at a gate node through the emission control line EML, can be activated. If the third transistor T3 and the fourth transistor T4 are activated, a high voltage VDDEL can be applied to the source node of the driving transistor DT. Accordingly, the driving current Id of the driving transistor DT generated by the difference between the gate node voltage of the driving transistor DT charged by the data voltage VDATA corresponding to the current frame and the source node voltage of the driving transistor DT can be applied to the light emitting device ED.

As described above, if the emission control signal EM is switched to a low voltage VGL in the tenth interval Interval 10, the fifth scan signal Scan5 can be switched to a high voltage VGH. Therefore, the switch transistor SWT that receives the fifth scan signal Scan5 at the gate node through the fifth scan line SL5 can be deactivated. Therefore, the driving current Id supplied through the driving transistor DT can be applied only to the first light emitting device ED1.

Embodiments of the present disclosure described above are briefly described as follows.

A display device according to embodiments of the present disclosure can include a normal area and an optical area capable of transmitting light, a plurality of light emitting devices disposed in each of the normal area and the optical area, a first pixel circuit configured to provide a driving current to at least one of the light emitting devices disposed in the optical area, and at least one switch transistors connected between the light emitting devices. The display device can further include an optical bezel area disposed between the normal area and the optical area and surrounding the optical area. The first pixel circuit can be disposed in the optical bezel area, and the first pixel circuit and a plurality of light emitting devices disposed in the optical area can be electrically connected through an anode extension line arranged from the optical bezel area to the optical area.

In addition, the entirety of the at least one switch transistors can be disposed in the optical bezel area. At least a part of the at least one switch transistors can bedisposed in the optical area. The optical bezel area can further include a plurality of light emitting devices, and a second pixel circuit providing a driving current to at least one of the light emitting devices disposed in the optical bezel area. The display device can further include at least one switch transistors connected between the light emitting devices disposed in the optical bezel area.

The light emitting devices disposed in the optical area can include a fifth light emitting device disposed in a first row and first column of the optical area, a sixth light emitting device disposed in a first row and second column of the optical area, a seventh light emitting device disposed in a first row and third column of the optical area, an eighth light emitting device disposed in a second row and first column of the optical area, a ninth light emitting device disposed in a second row and second column of the optical area, and a tenth light emitting device disposed in a second row and the third column of the optical area. The sixth light emitting device, the seventh light emitting device, the ninth light emitting device, and the tenth light emitting device can be electrically connected to each other and can output light of the same wavelength band.

A gate line can be arranged in the first row of the optical area, the gate line can not be arranged in the second row of the optical area, a data line can not be arranged in the first and third columns of the optical area, and the data line can be arranged in the second column of the optical area. When displaying the first text image in the optical area, the driving current can be applied to the sixth light emitting device, the seventh light emitting device, the ninth light emitting device, and the tenth light emitting device. A thickness of a stroke of the first text image displayed in the optical area can be greater than a thickness of a stroke of the first text image displayed in the normal area.

A gate line can be arranged in the first row of the optical area, the gate line can not be arranged in the second row of the optical area, a data line can not be arranged in the first and third columns of the optical area, and the data line can be arranged in the second column of the optical area. When displaying the first text image in the optical area, the driving current can be applied to the sixth light emitting device, and the driving current can not be applied to the seventh light emitting device, the ninth light emitting device, and the tenth light emitting device.

The strokes of the first text image displayed in the normal area can be displayed continuously, and strokes of the first text image displayed in the optical area can be displayed discontinuously. The at least one switch transistors can include a first switch transistor. The first switch transistor can be disposed at at least one of between the sixth light emitting device and the seventh light emitting device, between the seventh light emitting device and the ninth light emitting device, and between the ninth light emitting device and the tenth light emitting device. If a switch signal is applied to the first switch transistor, the driving current flowing to the remaining light emitting devices except for at least one light emitting device arranged between the first pixel circuit and the switch transistor can be blocked.

The at least one switch transistors can be disposed at at least one of between the first pixel circuit and the sixth light emitting device, between the sixth light emitting device and the seventh light emitting device, between the seventh light emitting device and the ninth light emitting device, and between the ninth light emitting device and the tenth light emitting device.

In all of the at least one switch transistors, a source electrode or a drain electrode of the at least one switch transistor can be directly connected to the first pixel circuit. The at least one switch transistors can be a P-type transistor that blocks the driving current when an activation signal is applied to a gate electrode. At least a part of the at least one switch transistors can receive an activation signal when an image corresponding to a text is output in the optical area.

The display device according to embodiments of the present disclosure can further include a plurality of transmission areas arranged in the optical area. The transmission areas can not overlap with the light emitting devices, the pixel circuit, and the switch transistor. An optical electronic device can be disposed in the optical area, and the optical electronic device can perform a predefined operation using light transmitted through the transmission area.

A display device according to embodiments of the present disclosure can include a normal area and an optical area surrounded by the normal area, M light emitting devices (M is a natural number greater than 3) arranged in the optical area, a first pixel circuit providing a driving current to N light emitting devices (N is a natural number greater than 1 and less than M) arranged in the optical area, and at least one switch transistor selectively blocking the driving current applied to a part of the N light emitting devices.

The above description has been presented to enable any person skilled in the art to make and use the technical idea of the present invention, and has been provided in the context of a particular application and its requirements. Various modifications, additions and substitutions to the described embodiments will be readily apparent to those skilled in the art, and the general principles defined herein can be applied to other embodiments and applications without departing from the spirit and scope of the present invention. The above description and the accompanying drawings provide an example of the technical idea of the present invention for illustrative purposes only. That is, the disclosed embodiments are intended to illustrate the scope of the technical idea of the present invention.

What is claimed is:

1. A display device comprising:
a display area and an optical area overlapping an electronic optical device disposed below the optical area;
a plurality of light emitting devices disposed in the display area and the optical area;
a first pixel circuit disposed outside of the optical area and electrically connected to first light emitting devices disposed in the optical area and configured to provide a driving current to the first light emitting devices disposed in the optical area; and
a second pixel circuit disposed in the display area and outside of the optical area and electrically connected to second light emitting devices disposed in the display area and configured to provide a driving current to the second light emitting devices disposed in the display area.

2. The display device of claim 1, further comprising:
an optical bezel area disposed between the display area and the optical area and surrounding the optical area,
wherein the first pixel circuit is disposed in the optical bezel area, and
wherein the first pixel circuit and the first light emitting devices are electrically connected through an anode extension line connecting the first pixel circuit in the optical bezel area to the first light emittng devices in the optical area.

3. The display device of claim 2, wherein the first pixel circuit includes a first driving transistor configured to drive the first light emitting devices in the optical area, and
wherein the first driving transistor is disposed in the optical bezel area and outside of the optical area.

4. The display device of claim 2, wherein the anode extension line of the first pixel circuit is connected to a row of first light emitting device disposed in the optical area.

5. The display device of claim 2, wherein the optical bezel area further comprises:
a plurality of third light emitting devices; and
a third pixel circuit electrically connected to the third light emitting devices and configured to providing a driving current to the third light emitting devices disposed in the optical bezel area,
wherein the third pixel circuit includes a third driving transistor electrically connected to the third light emitting devices disposed in the optical bezel area, and
wherein the third driving transistor is disposed in the optical bezel area and outside of the optical area.

6. The display device of claim 1, wherein of the first light emitting devices disposed in the optical area comprise:
a first light emitting element arranged in a first row and a first column of the optical area;
a second light emitting element arranged in the first row and a second column of the optical area;
a third light emitting element arranged in the first row and a third column of the optical area;
a fourth light emitting element arranged in a second row and the first column of the optical area;
a fifth light emitting element arranged in the second row and the second column of the optical area; and
a sixth light emitting element arranged in the second row and the third column of the optical area,
wherein a gate line for applying a scan signal to the first light emitting devices is arranged in the first row of the optical area,
wherein a data line for applying a data signal to the first light emitting devices is arranged in the first column of the optical area and the third column of the optical area, and
wherein the second light emitting element, the third light emitting element, the fifth light emitting element, and the sixth light emitting element are electrically connected to each other and output light of a same wavelength band.

7. The display device of claim 6, wherein the gate line is arranged in the first row of the optical area,
wherein the gate line is not arranged in the second row of the optical area,
wherein the data line is not arranged in the first column and the third column of the optical area,
wherein the data line is arranged in the second column of the optical area, and
wherein, when displaying a first text image in the optical area, the driving current is applied to the second light emitting element, the third light emitting element, the fifth light emitting element, and the sixth light emitting element.

8. The display device of claim 7, wherein a thickness of a stroke of the first text image displayed in the optical area is greater than a thickness of a stroke of the first text image displayed in the display area.

9. The display device of claim 6, wherein the gate line is arranged in the first row of the optical area,
wherein the gate line is not arranged in the second row of the optical area,
wherein the data line is not arranged in the first column and the third column of the optical area,
wherein the data line is arranged in the second column of the optical area, and
wherein, when displaying a first text image in the optical area, the driving current is applied to the second light emitting element, and the driving current is not applied to the third light emitting element, the fifth light emitting element, and the sixth light emitting element.

10. The display device of claim 9, wherein strokes of the first text image displayed in the display area are displayed continuously, and strokes of the first text image displayed in the optical area are displayed discontinuously.

11. The display device of claim 6, wherein a first switch transistor is disposed in an other than the display area at least one of between the second light emitting element and the third light emitting element, between the third light emitting element and the fifth light emitting element, and between the fifth light emitting element and the sixth light emitting element, and
wherein, when a switch signal is applied to the first switch transistor, the driving current flowing to remaining light emitting elements except for at least one light emitting element disposed between the first pixel circuit and the first switch transistor is blocked.

12. The display device of claim 6, wherein a first switch transistor is disposed in an other than the display area at least one of between the first pixel circuit and the second light emitting element, between the second light emitting elementand the third light emitting element, between the third light emitting element and the fifth light emitting element, and between the fifth light emitting element and the sixth light emitting element.

13. The display device of claim 6, wherein a first switch transistor is disposed in an other than the display area, and
whereina source electrode or a drain electrode of the first switch transistor is directly connected to the first pixel circuit.

14. The display device of claim 1, wherein a first switch transistor is disposed in an other than the display area and is a P-type transistor that blocks a driving current when an activation signal is applied to a gate electrode.

15. The display device of claim 1, wherein a first switch transistor is disposed in an other than the display area, and
wherein at least a part of the first switch transistor receives an activation signal when an image corresponding to text is output in the optical area.

16. The display device of claim 1, further comprising:
a plurality of light transmission areas arranged in the optical area so as not to overlap the first light emitting devices in the optical area.

17. The display device of claim 16, wherein the optical electronic device performs a predefined operation using light transmitted through the lighttransmission areas.

18. The display device of claim 1, wherein a first switch transistor is disposed between a first driving transistor of the the first pixel circuit and the first light emitting devices disposed in the optical area.

19. A display device comprising:
a display area and an optical area surrounded by the display area;
M light emitting devices (M is a natural number greater than 3) arranged in the optical area;
a first pixel circuit providing a driving current to N light emitting devices (N is a natural number greater than 1 and less than M) arranged in the optical area; and
at least one switch transistor selectively blocking the driving current applied to a part of the N light emitting devices.
